(19) United States
(12) Patent Application Publication
(10) Pub. No.: US 2012/0287998 A1
(43) Pub. Date: Nov. 15, 2012

(54) IMAGE PROCESSING APPARATUS AND METHOD

(76) Inventor: Kazushi Sato, Kanagawa (JP)

(21) Appl. No.: 13/521,729

(22) PCT Filed: Jan. 14, 2011
(86) PCT No.: PCT/JP2011/050493

§ 371 Date: Jul. 11, 2012

(30) Foreign Application Priority Data
Jan. 22, 2010 (JP) 201001214

(51) Int. Cl. H04N 7/32

(52) U.S. Cl. 375/240.12; 375/E07.243

(57) ABSTRACT

The present invention relates to an image processing apparatus and a method capable of improving the coding efficiency in intra prediction.

A spline parameter generation unit 92 calculates N spline parameters of an N−1 degree polynomial for intra prediction by solving N simultaneous equations using adjacent pixel values of N lines from a line buffer 74. A predicted image generation unit 82 generates a predicted image by using the N spline parameters calculated by the spline parameter generation unit 92 in the N−1 degree polynomial. The present invention may be applied to an image coding apparatus for coding based on the H.264/AVC scheme.

### TECHNICAL FIELD

The present invention relates to an image processing apparatus and method, and particularly to an image processing apparatus and method capable of increasing coding efficiency in intra prediction even when block size is large.

### BACKGROUND ART

In recent years, image compression and coding apparatuses have become increasingly common that handle image information digitally and that, with a view to achieving highly efficient transfer and storage of information, compress and code an image by adopting a coding scheme that compresses the image information by using orthogonal transform, such as discrete cosine transform, and motion compensation by taking advantage of redundancy uniquely associated with image information. An example of such a coding scheme is MPEG (Moving Picture Experts Group).

Particularly, MPEG2 (ISO/IEC 13818-2) is defined as a generic image coding scheme and describes a standard that exhaustively covers both interlace and progressive scan images, and standard and high-resolution images. For example, MPEG2 is currently used for a wide variety of applications, including professional and consumer applications. By using the MPEG2 compression scheme, a coding amount (bit rate) of 4 to 8 Mbps is allocated to a standard-resolution interlace scan image having 720×480 pixels, for example. Further, by using the MPEG2 compression scheme, a coding amount (bit rate) of 18 to 22 Mbps is allocated to a high-resolution interlace scan image having 1920×1088 pixels, for example. Thus, high compression ratios and image quality can be realized.

While MPEG2 has been mainly intended for high image quality coding suitable for broadcasting, it has not been adapted to coding schemes for coding amounts (bit rate) lower than those of MPEG1, i.e., coding schemes having higher compression ratios. With the expectation that the need for such coding schemes will increase in view of the increasingly widespread use of portable terminals, a MPEG4 coding scheme has been standardized. In terms of image coding scheme, the standard was adopted as an international standard referred to as ISO/IEC 14496-2 in December of 1998.

Further, in recent years, adoption of a standard called H.26L (ITU-T Q6/16 VCEG) is being discussed, initially for image coding for teleconference purposes. While H.26L requires more computation for coding and decoding than the conventional coding schemes such as MPEG2 and MPEG4, it is known to be capable of realizing higher coding efficiency. Currently, as part of the activities of MPEG4, a standardization effort is being made in the form of a Joint Model of Enhanced-Compression Video Coding based on H.26L and incorporating functions not supported by H.26L for realizing higher coding efficiency. In terms of standardization schedule, H.264 and MPEG-4 Part10 (Advanced Video Coding; hereafter referred to as “H.264/AVC”) were adopted in March 2003 as international standards.

Further, as an extension, standardization of FRExt (Fidelity Range Extension) that includes coding tools necessary for businesses, such as RGB, 4:2:2, and 4:4:4, and 8×8 DCT and quantization matrix specified by MPEG-2 has been completed in February 2005. This resulted in a coding scheme capable of satisfactorily expressing even film noise contained in movies by using H.264/AVC, and the scheme came to be used for wide applications including Blu-Ray Disc (trademark).

However, a growing need is felt for even higher compression ratio coding, involving compression of an image of 4000×2000 pixels, for example, which is four times higher than the number of pixels of a High-vision image. There is also increasing need for higher compression ratio coding, such as a demand for distributing High-vision images in an environment with limited transfer capacities, such as the Internet. Thus, discussions are continuously being made by the VCEG (=Video Coding Expert Group) under ITU-T for improving coding efficiency.

One of the factors enabling the H.264/AVC scheme to realize higher coding efficiency compared to the conventional MPEG2 scheme and the like is the adoption of an intra prediction scheme.

In the intra prediction scheme, with regard to the luminance signal, intra prediction modes including nine types of block units of 4×4 pixels and 8×8 pixels and four types of macroblock units of 16×16 pixels are defined. As regards the chrominance signal, four types of intra prediction modes including block units of 8×8 pixels are defined. The intra prediction mode for the chrominance signal may be set independently from the intra prediction mode for the luminance signal.

In the H.264/AVC scheme, a macroblock size has 16×16 pixels. However, the macroblock size of 16×16 pixels is not optimum for a large picture frame such as for UHD (Ultra High Definition; 4000×2000 pixels), for which the next-generation coding scheme may be intended.

Thus, it has been proposed to extend the macroblock size to 32×32 pixels, for example, in Non-Patent Document 1.

Non-Patent Document 1 proposes applying the extended macroblock to inter slice. Non-Patent Document 2 proposes applying the extended macroblock to intra slice.

### CITATION LIST

### Non-Patent Document

Non-Patent Document 1: “Video Coding Using Extended Block Sizes”, VCEG-AD09, ITU-Telecommunications Standardization Sector STUDY GROUP Question 16—Contribution 123, January 2009
Non-Patent Document 2: “Intra Coding Using Extended Block Sizes”, VCEG-AL28, July 2009

### SUMMARY OF THE INVENTION

### Problems to be Solved by the Invention

With reference to FIG. 1, a Vertical Prediction which is one of intra prediction modes for the block having 4×4 pixels and 8×8 pixels will be considered. FIG. 1A illustrates the block having 4×4 pixels. FIG. 1B illustrates the block having 8×8 pixels. The circles in FIGS. 1A and 1B represent pixels, with the white circles indicating the pixels in the block and the hatched circles indicating pixels used for prediction. The letters of the alphabet in the circles indicate pixel values of the pixels.

In the case of the 4×4 pixel block, a pixel value A is used as a predicted value for the pixels with the pixel values a through d, as illustrated in FIG. 1A. In the case of the 8×8 pixel block, the pixel value A is used as a prediction value for the pixels with the pixel values a through h, as illustrated in FIG. 1B.

Thus, the greater the block size as the unit of intra prediction, the farther are the pixels located that need to be predicted and which may have lower correlation. Namely, generally, as the block size increases, the efficiency of intra prediction may decrease.

This is also true when performing intra prediction particularly for the extended macroblock as proposed in Non-Patent Document 2.

The present invention has been made in view of the foregoing circumstances and aims to improve the coding efficiency in intra prediction.

### Solutions to Problems

An image processing apparatus according to a first aspect of the present invention includes a receiving means for receiving adjacent pixels of a plurality of lines for a current block; an intra prediction means for generating an intra prediction pixel value for the current block by performing an extrapolation process based on polynomial approximation using the adjacent pixels of the plurality of lines received by the receiving means; and a coding means for coding an image of the current block on the basis of the generated intra prediction pixel value for the current block.

The intra prediction means may include a parameter calculation means for calculating an interpolation parameter by polynomial approximation using the adjacent pixels of the plurality of lines, and a predicted image generation means for generating the intra prediction pixel value for the current block by using the interpolation parameter calculated by the parameter calculation means.

The intra prediction means may perform the extrapolation process by N−1 degree polynomial approximation when using the adjacent pixels of N (N<1) lines received by the receiving means.

The parameter calculation means may calculate N constants of the N−1 degree polynomial by solving N simultaneous equations using the adjacent pixels of the N lines. The predicted image generation means may generate the intra prediction pixel value for the current block by the N−1 degree polynomial using the N constants calculated by the parameter calculation means.

The predicted image generation means may clip the generated intra prediction pixel value in a range of 0 to 2^{N}−1 when an input signal includes an image signal of N bits.

The intra prediction means may perform the extrapolation process by the polynomial approximation of a degree corresponding to a result of detection of whether an object boundary is included in the adjacent pixels of the N lines received by the receiving means.

The intra prediction means may make the determination of the object boundary on the basis of difference information between pixels of the adjacent pixels.

The intra prediction means may make the determination of the object boundary by using a threshold determined in accordance with a quantization parameter on the basis of difference information between pixels of the adjacent pixels.

The threshold may be set to be larger for greater quantization parameter.

The intra prediction means may use the adjacent pixels of a number of the plurality of lines, the number of the lines corresponding to the magnitude of a block size of the current block.

An image processing method according to a first aspect of the present invention includes a receiving means of an image processing apparatus receiving adjacent pixels of a plurality of lines for a current block; an intra prediction means of the image processing apparatus generating an intra prediction pixel value for the current block by performing an extrapolation process based on polynomial approximation using the received adjacent pixels of the plurality of lines for the current block; and a coding means of the image processing apparatus coding an image of the current block on the basis of the generated intra prediction pixel value for the current block.

In the first aspect of the present invention, the adjacent pixels of a plurality of lines for the current block are received, and an extrapolation process is performed by polynomial approximation using the received adjacent pixels of the plurality of lines for the current block, thereby generating an intra prediction pixel value for the current block. An image of the current block is coded on the basis of the generated intra prediction pixel value for the current block.

An image processing apparatus according to a second aspect of the present invention includes a decoding means for acquiring an intra prediction mode by decoding coded information coding an image of a current block; a receiving means for receiving adjacent pixels of a plurality of lines for the current block in accordance with the intra prediction mode; and an intra prediction means for generating an intra prediction pixel value for the current block by performing an extrapolation process based on polynomial approximation using the adjacent pixels of the plurality of lines received by the receiving means.

An image processing method according to the second aspect of the present invention includes a decoding means of an image processing apparatus acquiring an intra prediction mode by decoding coded information coding an image of a current block; a receiving means of the image processing apparatus receiving adjacent pixels of a plurality of lines for the current block in accordance with the intra prediction mode; and an intra prediction means of the image processing apparatus generating an intra prediction pixel value for the current block by performing an extrapolation process based on polynomial approximation using the received adjacent pixels of the plurality of lines for the current block.

In the second aspect of the present invention, the coded information coding an image of the current block is decoded to acquire the intra prediction mode, the adjacent pixels of a plurality of lines for the current block are received in accordance with the intra prediction mode, and the intra prediction pixel value for the current block is generated by performing an extrapolation process based on polynomial approximation using the received adjacent pixels of the plurality of lines.

The image processing apparatus may include an independent apparatus or an internal block of an image coding apparatus or an image decoding apparatus.

### Effects of the Invention

In accordance with the present invention, the coding efficiency in intra prediction can be improved. Particularly, in accordance with the present invention, the coding efficiency in intra prediction can be improved in the case of large block sizes.

### BRIEF DESCRIPTION OF DRAWINGS

FIG. 1 illustrates conventional intra prediction.

FIG. 2 is a block diagram of a configuration of an embodiment of an image coding apparatus to which the present invention is applied.

FIG. 3 illustrates a process sequence in the case of a 16×16 pixel intra prediction mode.

FIG. 4 illustrates types of a 4×4 pixel intra prediction mode for the luminance signal.

FIG. 5 illustrates the types of the 4×4 pixel intra prediction mode for the luminance signal.

FIG. 6 illustrates directions of 4×4 pixel intra prediction.

FIG. 7 illustrates 4×4 pixel intra prediction.

FIG. 8 illustrates coding of the luminance signal in the 4×4 pixel intra prediction mode.

FIG. 9 illustrates types of an 8×8 pixel intra prediction mode for the luminance signal.

FIG. 10 illustrates the types of the 8×8 pixel intra prediction mode for the luminance signal.

FIG. 11 illustrates types of a 16×16 pixel intra prediction mode for the luminance signal.

FIG. 12 illustrates the types of the 16×16 pixel intra prediction mode for the luminance signal.

FIG. 13 illustrates 16×16 pixel intra prediction.

FIG. 14 illustrates types of an intra prediction mode for the chrominance signal.

FIG. 15 illustrates intra prediction in an image coding apparatus 51 illustrated in FIG. 2.

FIG. 16 illustrates a method of determining the degree of a polynomial.

FIG. 17 illustrates an example of a macroblock.

FIG. 18 is a block diagram of a configuration of an intra prediction unit and a spline interpolation unit illustrated in FIG. 2.

FIG. 19 is a flowchart of a coding process in the image coding apparatus of FIG. 2.

FIG. 20 is a flowchart of an intra prediction process in step S21 of FIG. 19.

FIG. 21 is a flowchart of an inter motion prediction process in step S22 of FIG. 19.

FIG. 22 is a flowchart of a process of determining the degree of polynomial approximation in the image coding apparatus of FIG. 2.

FIG. 23 is a block diagram of a configuration of an embodiment of an image decoding apparatus to which the present invention is applied.

FIG. 24 is a block diagram of a configuration of an intra prediction unit and a spline interpolation unit illustrated in FIG. 23.

FIG. 25 is a flowchart of a decoding process in the image decoding apparatus of FIG. 23.

FIG. 26 is a flowchart of a prediction process in step S138 of FIG. 25.

FIG. 27 is a block diagram of a hardware configuration of a computer.

FIG. 28 is a block diagram of a main configuration of a television receiver to which the present invention is applied.

FIG. 29 is a block diagram of a main configuration of a portable telephone to which the present invention is applied.

FIG. 30 is a block diagram of a main configuration of a hard disk recorder to which the present invention is applied.

FIG. 31 is a block diagram of a main configuration of a camera to which the present invention is applied.

FIG. 32 illustrates a Coding Unit according to a HEVC coding scheme.

### MODE FOR CARRYING OUT THE INVENTION

In the following, embodiments of the present invention will be described with reference to the drawings.

### [Example of Configuration of Image Coding Apparatus]

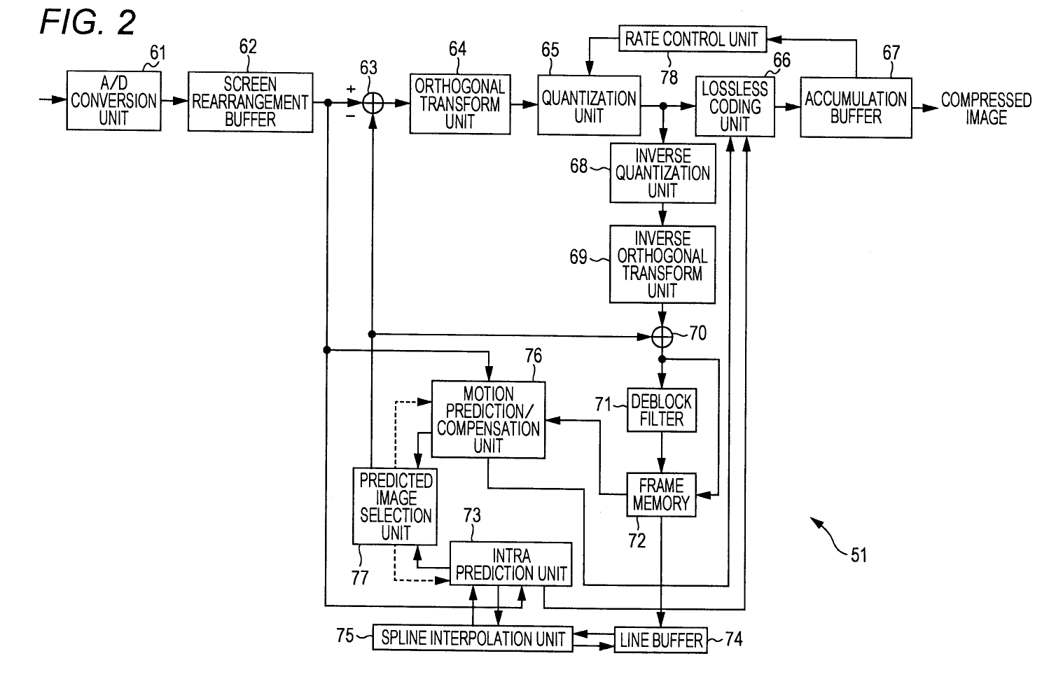

FIG. 2 illustrates a configuration of an embodiment of an image coding apparatus as an image processing apparatus to which the present invention is applied.

An image coding apparatus 51 compresses and codes an image by using a coding scheme based on H.264 and MPEG-4 Part 10 (Advanced Video Coding) (hereafter referred to as “H.264/AVC”), for example.

In the example of FIG. 2, the image coding apparatus 51 includes an A/D conversion unit 61, a screen rearrangement buffer 62, an arithmetic unit 63, an orthogonal transform unit 64, a quantization unit 65, a lossless coding unit 66, an accumulation buffer 67, an inverse quantization unit 68, an inverse orthogonal transform unit 69, an arithmetic unit 70, a deblocking filter 71, a frame memory 72, an intra prediction unit 73, a line buffer 74, a spline interpolation unit 75, a motion prediction/compensation unit 76, a predicted image selection unit 77, and a rate control unit 78.

The A/D conversion unit 61 performs A/D conversion on an input image, outputs the converted image to the screen rearrangement buffer 62, and has the converted image stored therein. The screen rearrangement buffer 62 rearranges the images of frames stored in the order of display into the order of frames for coding in accordance with GOP (Group of Picture).

The arithmetic unit 63 subtracts from an image read from the screen rearrangement buffer 62 a predicted image from the intra prediction unit 73 or a predicted image from the motion prediction/compensation unit 76 that is selected by the predicted image selection unit 77, and outputs resultant difference information to the orthogonal transform unit 64. The orthogonal transform unit 64 performs orthogonal transform, such as discrete cosine transform or Karhunen-Loève Transform, on the difference information from the arithmetic unit 63, and outputs a resultant transform coefficient. The quantization unit 65 quantizes the transform coefficient output from the orthogonal transform unit 64.

The quantized transform coefficient output from the quantization unit 65 is input into the lossless coding unit 66, by which the quantized transfer coefficient is compressed by lossless coding, such as variable length coding or arithmetic coding, for example.

The lossless coding unit 66 acquires information indicating intra prediction, for example, from the intra prediction unit 73 and information indicating an inter prediction mode, for example, from the motion prediction/compensation unit 76. The information indicating intra prediction may be hereafter referred to as “intra prediction mode information”. The information indicating the information mode indicating inter prediction may be hereafter referred to as “inter prediction mode information”.

The lossless coding unit 66 codes the information indicating intra prediction, the information indicating inter prediction mode, and a quantization parameter, for example, as well as coding the quantized transform coefficient, and makes those information a part of header information of the compressed image. The lossless coding unit 66 supplies the coded data to the accumulation buffer 67 for storage therein.

For example, the lossless coding unit 66 performs a lossless coding process such as variable length coding or arithmetic coding. The variable length coding may include the CAVLC (Context-Adaptive Variable Length Coding) specified by the H.264/AVC scheme. The arithmetic coding may include the CABAC (Context-Adaptive Binary Arithmetic Coding).

The accumulation buffer 67 outputs the data supplied from the lossless coding unit 66 to a recording apparatus in a subsequent stage or a transfer path, which are not illustrated, as a compressed image coded by the H.264/AVC scheme.

The quantized transform coefficient output from the quantization unit 65 is also input to the inverse quantization unit 68, where the coefficient is inversely quantized and is further subjected to inverse orthogonal transform in the inverse orthogonal transform unit 69. The inversely orthogonal-transformed output is summed with the predicted image supplied from the predicted image selection unit 77 in the arithmetic unit 70, thereby obtaining a locally decoded image. The deblocking filter 71 removes block distortion in the decoded image and then supplies the decoded image to the frame memory 72 for storage therein. The frame memory 72 is also supplied with the image prior to the deblocking filter process by the deblocking filter 71, and the image is stored therein.

In the image coding apparatus 51, an I-picture, a B-picture, and a P-picture from the screen rearrangement buffer 62 are supplied to the intra prediction unit 73 as images for intra prediction (which may be also referred to as “intra process”). The B-picture and the P-picture read from the screen rearrangement buffer 62 are also supplied to the motion prediction/compensation unit 76 as images for inter prediction (which may be also referred to as “inter process”).

The intra prediction unit 73 performs an intra prediction process on the images read from the screen rearrangement buffer 62 for intra prediction in all of candidate intra prediction modes, thereby generating predicted images.

At this time, the intra prediction unit 73 generates intra prediction pixel values of a current block by performing, together with the spline interpolation unit 75, an extrapolation process based on polynomial approximation using adjacent pixels of a plurality of lines stored in the line buffer 74.

Specifically, the intra prediction unit 73 supplies information of the candidate intra prediction modes to the spline interpolation unit 75. The spline interpolation unit 75 supplies parameters (interpolation parameters) of a polynomial that approximates the adjacent pixels and the pixels of the current block for intra prediction using the adjacent pixel values in accordance with the intra prediction modes. The intra prediction unit 73 generates intra predicted images of the candidate intra prediction modes in accordance with the polynomial using the parameters from the spline interpolation unit 75.

The intra prediction unit 73 calculates cost function values for the intra prediction modes in which the predicted images have been generated, and selects an intra prediction mode that provides the minimum value of the calculated cost function values as an optimum intra prediction mode. The intra prediction unit 73 supplies the predicted image generated in the optimum intra prediction mode and the cost function value calculated for the corresponding optimum intra prediction mode to the predicted image selection unit 77.

When the predicted image generated in the optimum intra prediction mode is selected by the predicted image selection unit 77, the intra prediction unit 73 supplies information indicating the optimum intra prediction mode to the lossless coding unit 66. The lossless coding unit 66, upon reception of the information from the intra prediction unit 73, codes the information and makes it a part of the header information of the compressed image.

The line buffer 74 stores the pixel values of a reference image from the frame memory 72. The line buffer 74 is supplied from the spline interpolation unit 75 with the addresses of the adjacent pixels in accordance with the intra prediction modes. The line buffer 74 supplies the pixel values of the adjacent pixels corresponding to the addresses to the spline interpolation unit 75.

The spline interpolation unit 75 calculates the interpolation parameters of the polynomial for intra prediction based on polynomial approximation by using the adjacent pixel values supplied from the line buffer 74 in accordance with the addresses of the adjacent pixels corresponding to the intra prediction mode from the intra prediction unit 73, and supplies the calculated interpolation parameters to the intra prediction unit 73.

The motion prediction/compensation unit 76 performs a motion prediction/compensation process on all of the candidate inter prediction modes. Specifically, the motion prediction/compensation unit 76 is supplied with the images for inter process read from the screen rearrangement buffer 62, and with the reference image from the frame memory 72. The motion prediction/compensation unit 76, on the basis of the images for inter process and the reference image, detects motion vectors in all of the candidate inter prediction modes, and performs a compensation process on the reference image on the basis of the motion vectors, thereby generating a predicted image.

Further, the motion prediction/compensation unit 76 calculates the cost function values for all of the candidate inter prediction modes. The motion prediction/compensation unit 76 determines the prediction mode that provides the minimum value of the calculated cost function values as an optimum inter prediction mode.

The motion prediction/compensation unit 76 supplies the predicted image generated in the optimum inter prediction mode and its cost function value to the predicted image selection unit 77. When the predicted image generated in the optimum inter prediction mode is selected by the predicted image selection unit 77, the motion prediction/compensation unit 76 outputs information indicating the optimum inter prediction mode (inter prediction mode information) to the lossless coding unit 66.

If necessary, motion vector information, flag information, and reference frame information and the like may also be output to the lossless coding unit 66. The lossless coding unit 66 subjects the information from the motion prediction/compensation unit 76 also to the lossless coding process, such as variable length coding or arithmetic coding, and inserts the processed information in the header portion of the compressed image.

The predicted image selection unit 77, on the basis of the respective cost function value output from the intra prediction unit 73 or the motion prediction/compensation unit 76, determines an optimum prediction mode from the optimum intra prediction mode and the optimum inter prediction mode. Then, the predicted image selection unit 77 selects the predicted image of the determined optimum prediction mode and supplies it to the arithmetic units 63 and 70. At this time, the predicted image selection unit 77 supplies selection information of the predicted image to the intra prediction unit 73 or the motion prediction/compensation unit 76.

The rate control unit 78, on the basis of the compressed images accumulated in the accumulation buffer 67, controls the rate of quantization operation of the quantization unit 65 via a quantization parameter so as to prevent overflow or underfloor

### [Description of Intra Prediction Process in H.264/AVC Scheme]

Each of intra prediction modes defined by the H.264/AVC scheme will be described.

First, an intra prediction mode for the luminance signal will be described. For the intra prediction mode for the luminance signal, three schemes are determined; namely an intra 4×4 prediction mode; an intra 8×8 prediction mode; and an intra 16×16 prediction mode. These are modes for determining the block unit and are set on a macroblock basis. For the chrominance signal, the intra prediction mode can be set independently of the luminance signal on a macroblock basis.

In the case of the intra 4×4 prediction mode, one prediction mode may be set from nine types of prediction modes on a 4×4 pixel current block basis. In the case of the intra 8×8 prediction mode, one prediction mode may be set from nine types of prediction modes on a 8×8 pixel current block basis. In the case of the intra 16×16 prediction mode, one prediction mode may be set from four types of prediction modes for a 16×16 pixel current macroblock.

In the following, the intra 4×4 prediction mode, the intra 8×8 prediction mode, and the intra 16×16 prediction mode may be referred to as a “4×4 pixel intra prediction mode”, a “8×8 pixel intra prediction mode”, and a “16×16 pixel intra prediction mode”, respectively.

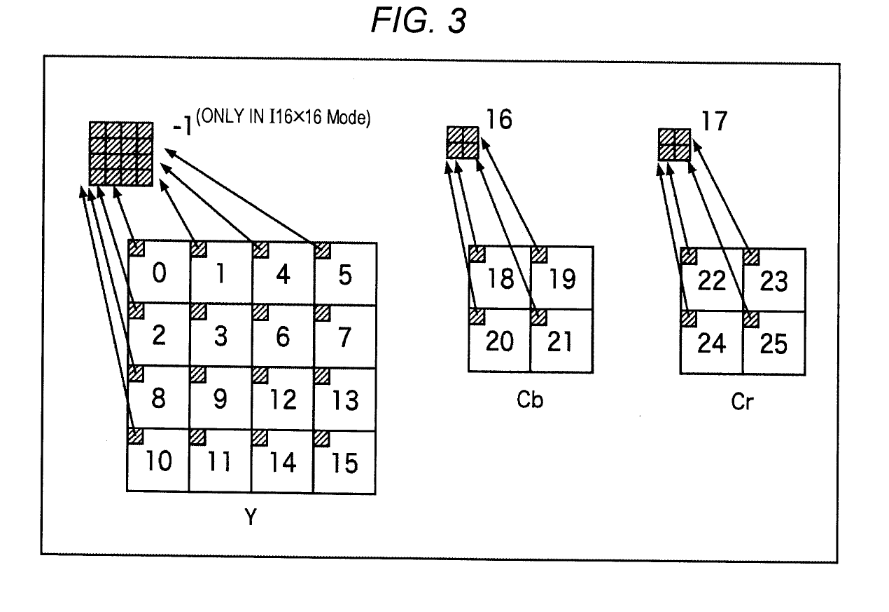

In the example of FIG. 3, the numbers −1 through 25 allocated to the blocks represent the bit stream order (process order on the decoding side) of each block. With regard to the luminance signal, the macroblock is partitioned into 4×4 pixels, and a 4×4 pixel DCT is performed. Only in the case of the intra 16×16 prediction mode, direct-current components are collected from each of the blocks to generate a 4×4 matrix, as illustrated by a “−1” block, which is further subjected to orthogonal transform.

On the other hand, with regard to the chrominance signal, the macroblock is partitioned into 4×4 pixels and, after a 4×4 pixel DCT is performed, direct-current components are collected from each of the blocks to generate a 2×2 matrix, as illustrated by blocks 16 and 17, which is further subjected to orthogonal transform.

It should be noted that, with regard to the intra 8×8 prediction mode, the above is only applicable to the case where the current macroblock is subjected to 8×8 orthogonal transform in a high profile or higher profile.

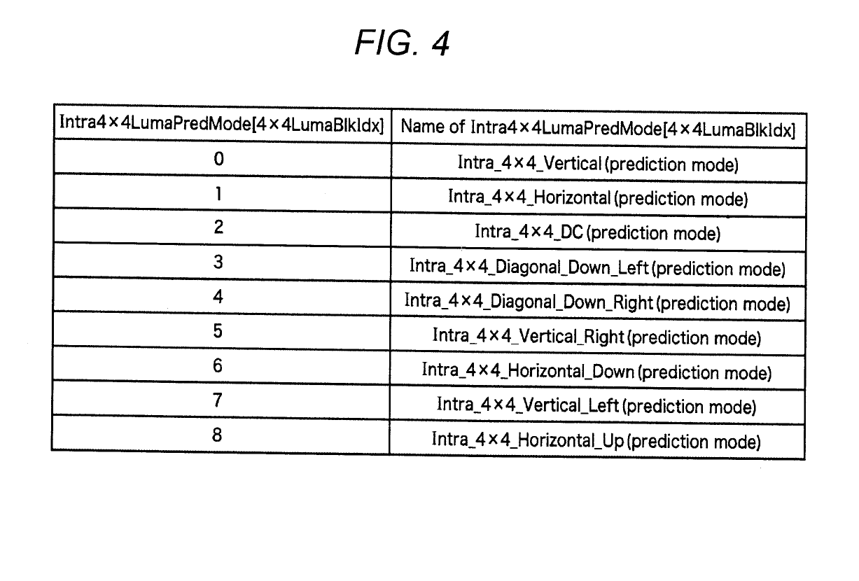

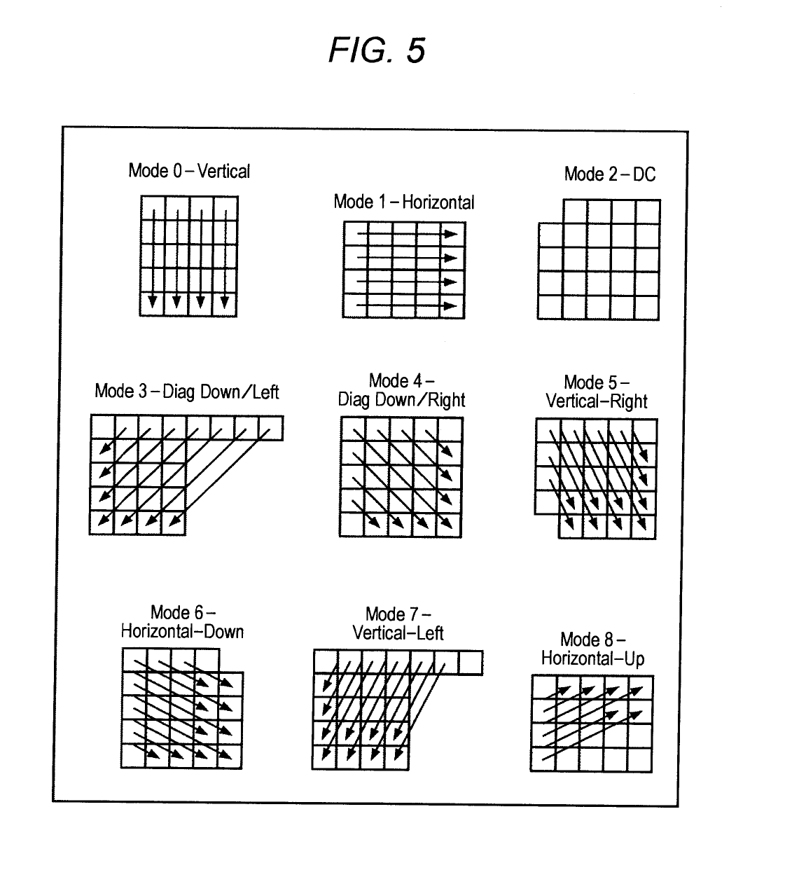

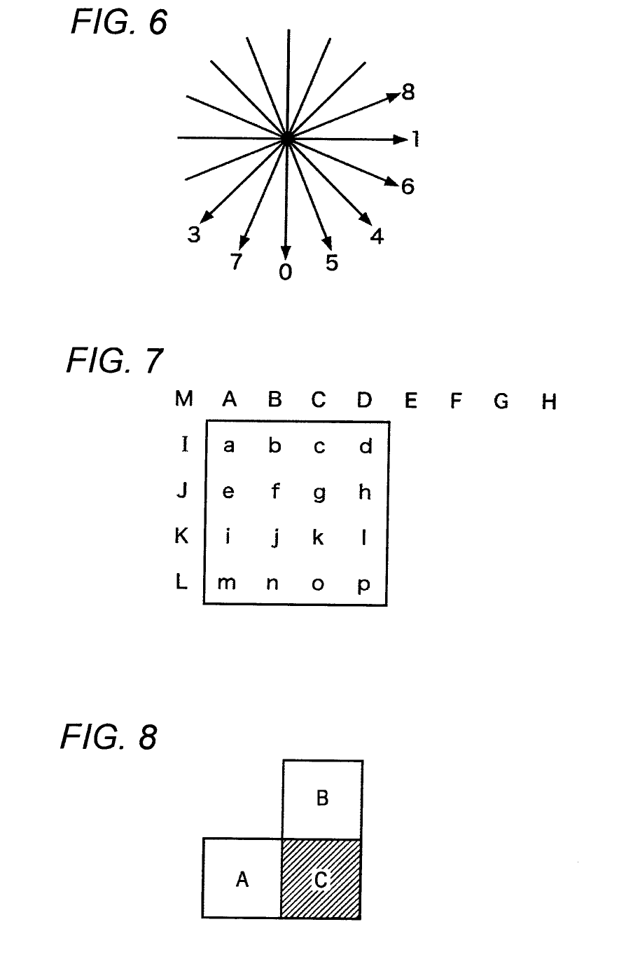

FIGS. 4 and 5 illustrate nine types of 4×4 pixel intra prediction modes for the luminance signal (Intra_{—}4×4_pred_mode). The eight types of the modes other than mode 2, which indicates an average value (DC) prediction, correspond to the directions indicated by the numbers 0, 1, and 3 through 8 in FIG. 6.

The nine types of Intra_{—}4×4_pred_modes will be described with reference to FIG. 7. In the example of FIG. 7, pixels a through p represent pixels of the current block subjected to intra process, while pixel values A through M represent pixel values of the pixels belonging to adjacent blocks. Specifically, the pixels a through p are of the process target image read from the screen rearrangement buffer 62, and the pixel values A through M are the pixel values of a decoded image that is read from the frame memory 72 and referenced.

In the case of the intra prediction modes of FIGS. 4 and 5, predicted pixel values for the pixels a through p are generated by using the pixel values A through M of the pixels of the adjacent blocks as follows. When a pixel value is “available”, the pixel value is available because there are no reasons such as that the pixel value is at the edge of the picture frame or that it is not yet coded. When a pixel value is “unavailable”, the pixel value is not available because of reasons such as that the pixel value is at the edge of the picture frame or that it is not yet coded.

Mode 0 is a Vertical Prediction mode and is applied only when the pixel values A through D are “available”. In this case, the predicted pixel values for the pixels a through p are generated according to the following expression (1).

Predicted pixel values for pixels a, e, i, and m=A

Predicted pixel values for pixels b, f, j, and n=B

Predicted pixel values for pixels c, g, k, and o=C

Predicted pixel values for pixels d, h, l, and p=D (1)

Mode 1 is a Horizontal Prediction mode and is applied only when the pixel values I through L are “available”. In this case, the predicted pixel values for the pixels a through p are generated according to the following expression (2).

Predicted pixel values for pixels a, b, c, and d=I

Predicted pixel values for pixels e, f, g, and h=J

Predicted pixel values for pixels i, j, k, and l=K

Predicted pixel values for pixels m, n, o, and p=L (2)

Mode 2 is a DC Prediction mode where, when all of the pixel values A, B, C, D, I, J, K, and L are “available”, the predicted pixel values are generated according to the following expression (3).

(A+B+C+D+I+J+K+L+4)>>3 (3)

When all of the pixel values A, B, C, and D are “unavailable”, the predicted pixel values are generated according to the following expression (4).

(I+J+K+L+2)>>2 (4)

When all of the pixel values I, J, K, and L are “unavailable”, the predicted pixel values are generated according to the following expression (5).

(A+B+C+D+2)>>2 (5)

When all of the pixel values A, B, C, D, I, J, K, and L are “unavailable”, 128 is used as the predicted pixel values.

Mode 3 is a Diagonal_Down_Left Prediction mode and is applied only when the pixel values A, B, C, D, I, J, K, L, and M are “available”. In this case, the predicted pixel values for the pixels a through p are generated according to the following expression (6).

Predicted pixel value for pixel a=(A+2B+C+2)>>2

Predicted pixel value for pixels b and e=(B+2C+D+2)>>2

Predicted pixel value for pixels c, f, and i=(C+2D+E+2)>>2

Predicted pixel values for pixels d, g, j, and m=(D+2E+F+2)>>2

Predicted pixel values for pixels h, k, and n=(E+2F+G+2)>>2

Predicted pixel values for pixels l and o=(F+2G+H+2)>>2

Predicted pixel value for pixel p=(G+3H+2)>>2 (6)

Mode 4 is a Diagonal_Down_Right Prediction mode and is applied only when the pixel values A, B, C, D, I, J, K, L, and M are “available”. In this case, the predicted pixel values for the pixels a through p are generated according to the following expression (7).

Predicted pixel value for pixel m=(J+2K+L+2)>>2

Predicted pixel values for pixels i and n=(I+2J+K+2)>>2

Predicted pixel values for pixels e, j, and o=(M+2I+J+2)>>2

Predicted pixel values for pixels a, f, k, and p=(A+2M+I+2)>>2

Predicted pixel values for pixels b, g, and l=(M+2A+B+2)>>2

Predicted pixel values for pixels c and h=(A+2B+C+2)>>2

Predicted pixel value for pixel d=(B+2C+D+2)>>2 (7)

Mode 5 is a Diagonal_Vertical_Right Prediction mode and is applied only when the pixel values A, B, C, D, I, J, K, L, and M are “available”. In this case, the predicted pixel values for the pixels a through p are generated according to the following expression (8).

Predicted pixel values for pixels a and j=(M+A+1)>>1

Predicted pixel values for pixels b and k=(A+B+1)>>1

Predicted pixel values for pixels c and l=(B+C+1)>>1

Predicted pixel value for pixel d=(C+D+1)>>1

Predicted pixel values for pixels e and n=(I+2M+A+2)>>2

Predicted pixel values for pixels f and o=(M+2A+B+2)>>2

Predicted pixel values for pixels g and p=(A+2B+C+2)>>2

Predicted pixel value for pixel h=(B+2C+D+2)>>2

Predicted pixel value for pixel i=(M+2I+J+2)>>2

Predicted pixel value for pixel m=(I+2J+K+2)>>2 (8)

Mode 6 is a Horizontal_Down Prediction mode and is applied only when the pixel values A, B, C, D, I, J, K, L, and M are “available”. In this case, the predicted pixel values for the pixels a through p are generated according to the following expression (9).

Predicted pixel values for pixels a and g=(M+I+1)>>1

Predicted pixel values for pixels b and h=(I+2M+A+2)>>2

Predicted pixel value for pixel c=(M+2A+B+2)>>2

Predicted pixel value for pixel d=(A+2B+C+2)>>2

Predicted pixel values for pixels e and k=(I+J+1)>>1

Predicted pixel values for pixels f and l=(M+2I+J+2)>>2

Predicted pixel values for pixels i and o=(J+K+1)>>1

Predicted pixel values for pixels j and p=(I+2J+K+2)>>2

Predicted pixel value for pixel m=(K+L+1)>>1

Predicted pixel value for pixel n=(J+2K+L+2)>>2 (9)

Mode 7 is a Vertical_Left Prediction mode and is applied only when the pixel values A, B, C, D, I, J, K, L, and M are “available”. In this case, the predicted pixel values for the pixels a through p are generated according to the following expression (10).

Predicted pixel value for pixel a=(A+B+1)>>1

Predicted pixel values for pixels b and i=(B+C+1)>>1

Predicted pixel values for pixels c and j=(C+D+1)>>1

Predicted pixel values for pixels d and k=(D+E+1)>>1

Predicted pixel value for pixel l=(E+F+1)>>1

Predicted pixel value for pixel e=(A+2B+C+2)>>2

Predicted pixel values for pixels f and m=(B+2C+D+2)>>2

Predicted pixel values for pixel g and n=(C+2D+E+2)>>2

Predicted pixel values for pixels h and o=(D+2E+F+2)>>2

Predicted pixel value for pixel p=(E+2F+G+2)>>2 (10)

Mode 8 is a Horizontal_Up Prediction mode and applied only when the pixel values A, B, C, D, I, J, K, L, and M are “available”. In this case, the predicted pixel values for the pixels a through p are generated according to the following expression (11).

Predicted pixel value for pixel a=(I+J+1)>>1

Predicted pixel value for pixel b=(I+2J+K+2)>>2

Predicted pixel values for pixels c and e=(J+K+1)>>1

Predicted pixel values for pixels d and f=(J+2K+L+2)>>2

Predicted pixel values for pixels g and i=(K+L+1)>>1

Predicted pixel values for pixels h and j=(K+3L+2)>>2

Predicted pixel values for pixels k, l, m, n, o, and p=L (11)

Next, with reference to FIG. 8, a coding scheme for a 4×4 pixel intra prediction mode for the luminance signal (Intra_{—}4×4_pred_mode) will be described. FIG. 8 illustrates an example of a current block C having 4×4 pixels as a coding target and blocks A and B adjacent the current block C and each having 4×4 pixels.

In this case, it can be thought that the Intra_{—}4×4_pred_mode in the current block C and the Intra_{—}4×4_pred_mode in the block A and the block B have high correlation. By utilizing this correlation, increased coding efficiency can be realized by performing a coding process as follows.

In the example of FIG. 8, the Intra_{—}4×4_pred_mode in the block A and the block B is designated as an “Intra_{—}4×4_pred_modeA” and an “Intra_{—}4×4_pred_modeB”, respectively, and a MostProbableMode is defined as follows.

MostProbableMode=Min(Intra_{—}4×4_pred_modeA,Intra_{—}4×4_pred_modeB) (12)

Namely, one of the block A and the block B that is allocated a smaller mode number is designated the MostProbableMode.

In a bit stream, as parameters for the current block C, two values “prev_intra4×4_pred_mode_flag[luma4×4BlkIdx]” and “rem_intra4×4_pred_mode[luma4×4BlkIdx]” are defined. A decoding process is performed via a process based on a pseudocode indicated by the following expression (13), whereby the value of Intra_{—}4×4_pred_mode for the current block C, Intra_{—}4×4PredMode[luma4×4BlkIdx], can be obtained.

$$if ( prev\_intra 4 \times 4 \_pred \_mode \_flag [ luma 4 \times 4 BlkIdx ] ) \\ Intra 4 \times 4 PredMode [ luma 4 \times 4 BlkIdx ] = MostProbableMode \\ else \\ if ( rem\_intra 4 \times 4 \_pred \_mode [ luma 4 \times 4 BlkIdx ] < MostProbableMode ) \\ Intra 4 \times 4 PredMode [ luma 4 \times 4 BlkIdx ] = rem\_intra 4 \times 4 \_pred \_mode [ luma 4 \times 4 BlkIdx ] \\ else \\ Intra 4 \times 4 PredMode [ luma 4 \times 4 BlkIdx ] = rem\_intra 4 \times 4 \_pred \_mode [ luma 4 \times 4 BlkIdx ] + 1 \qquad ( 13 )$$

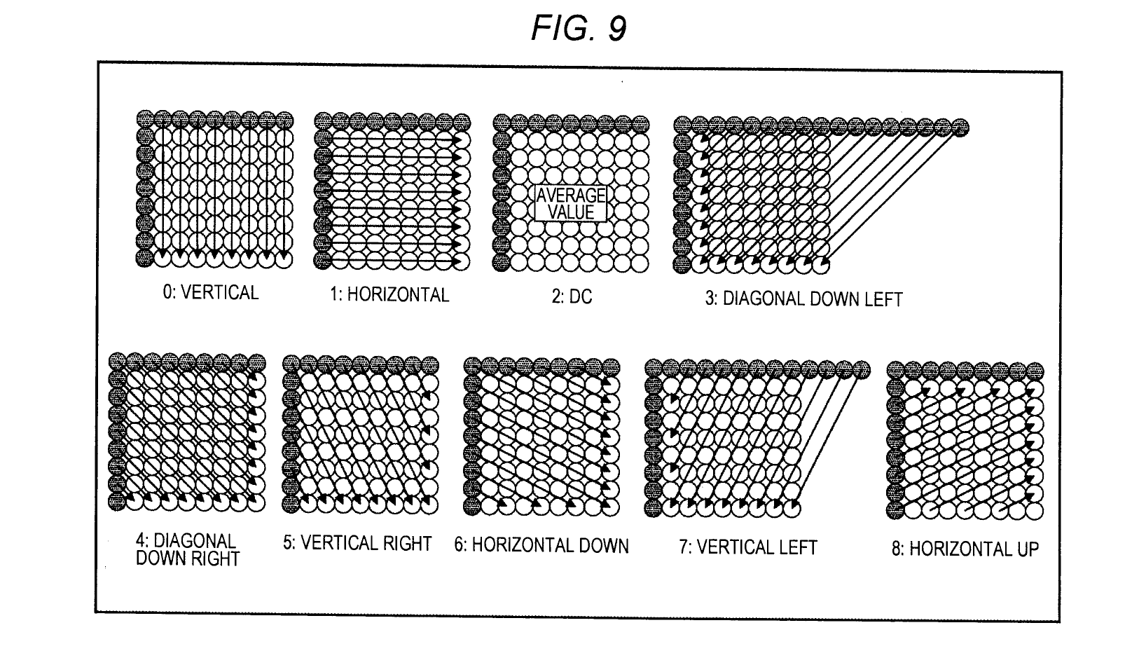

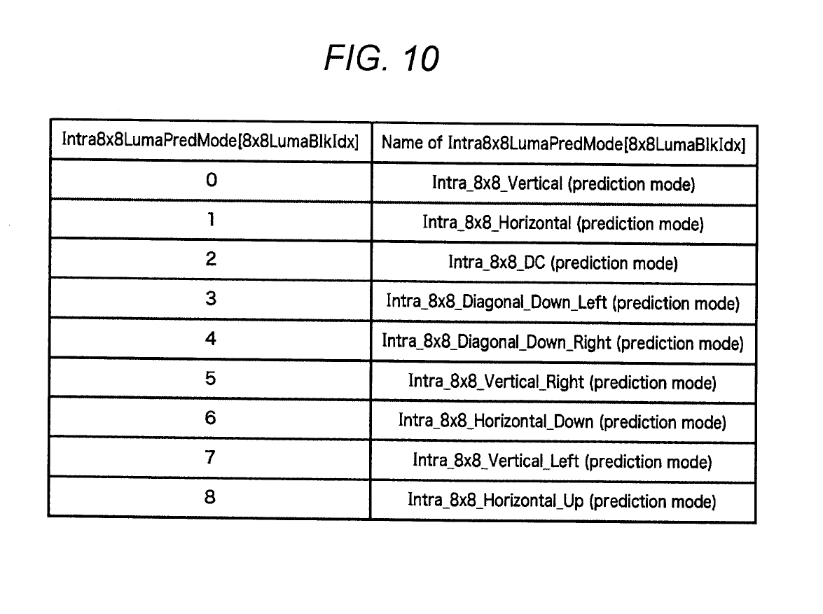

Next, an 8×8 pixel intra prediction mode will be described. FIGS. 9 and 10 illustrate nine types of 8×8 pixel intra prediction modes (Intra_{—}8×8pred_mode) for the luminance signal.

The pixel values in a current 8×8 block are represented as p[x, y] (0≦x≦7; 0≦y≦7), and the pixel values of the adjacent blocks are represented as p[−1, −1], . . . , p[−1, 15], p[−1, 0], . . . , [p−1, 7].

As regards the 8×8 pixel intra prediction mode, a low-pass filtering process is performed on the adjacent pixels prior to generating a predicted value. The pixel values prior to the low-pass filtering process are represented as p[−1, −1], . . . , p[−1, 15], p[−1, 0], . . . p[−1, 7], and the pixel values after the process are represented as p′[−1, −1], . . . , p′[−1, 15], p′[1−1, 0], . . . p′[−1, 7].

First, when p[−1, −1] is “available”, p′[0, −1] is calculated according to the following expression (14). When “not available”, p′[0, −1] is calculated according to the following expression (15).

p′[0,−1]=(p[−1,−1]+2*p[0,−1]+p[1,−1]+2)>>2 (14)

p′[0,−1]=(3*p[0,−1]+p[1,−1]+2)>>2 (15)

p′[x,−1] (x=0, . . . , 7) is calculated according to the following expression (16).

p′[x,−1]=(p[x−1,−1]+2*p[x,−1]+p[x+1,−1]+2)>>2 (16)

When p[x, −1] (x=8, . . . , 15) is “available”, p′[x, −1] (x=8, . . . , 15) is calculated according to the following expression (17).

p′[x,−1]=(p[x−1,−1]+2*p[x,−1]+p[x+1,−1]+2)>>2

p′[15,−1]=(p[14,−1]+3*p[15,−1]+2)>>2 (17)

When p[−1, −1] is “available”, p′[−1, −1] is calculated as follows. Namely, p′[−1, −1] is calculated according to the expression (18) when both p[0, −1] and p[−1, 0] are available and according to the expression (19) when p[−1, 0] is “unavailable”. When p[0,−1] is “unavailable”, p′[−1, −1] is calculated according to the expression (20).

p′[−1,−1]=(p[0,−1]+2*p[−1,−1]+p[−1,0]+2)>>2 (18)

p′[−1,−1]=(3*p[−1,−1]+p[0,−1]+2)>>2 (19)

p′[−1,−1]=(3*p[−1,−1]+p[−1,0]+2)>>2 (20)

When p[−1, y] (y=0, . . . , 7) is “available”, p′[−1, y] (y=0, . . . , 7) is calculated as follows. Namely, p′[−1, 0] is calculated according to the following expression (21) when p[−1, −1] is “available” and according to the expression (22) when p[−1, −1] is “unavailable”.

p′[−1,0]=(p[−1,−1]+2*p[−1,0]+p[−1,1]+2)>>2 (21)

p′[−1,0]=(3*p[−1,0]+p[−1,1]+2)>>2 (22)

p′[−1, y] (y=1, . . . , 6) is calculated according to the following expression (23), and p′[−1, 7] is calculated according to the expression (24).

p[−1,y]=(p[−1,y−1]+2*p[−1,y]+p[−1,y+1]+2)>>2 (23)

p′[−1,7]=(p[−1,6]+3*p[−1,7]+2)>>2 (24)

By using the p′ thus calculated, the predicted values in the intra prediction modes illustrated in FIGS. 9 and 10 are generated as follows.

Mode 0 is a Vertical Prediction mode and applied only when p[x, −1] (x=0, . . . , 7) is “available”. A predicted value pred8×8_{L}[x, y] is generated according to the following expression (25).

pred8×8_{L}[x,y]=p′[x,−1] x,y=0, . . . , 7 (25)

Mode 1 is a Horizontal Prediction mode and applied only when p[−1, y] (y=0, . . . , 7) is “available”. The predicted value pred8×8_{L}[x, y] is generated according to the following expression (26).

pred8×8_{L}[x,y]=p′[−1,y] x,y=0, . . . , 7 (26)

Mode 2 is a DC Prediction mode where the predicted value pred8×8_{L}[x, y] is generated as follows. Namely, when both p[x, −1] (x=0, . . . , 7) and p[−1, y] (y=0, . . . , 7) are “available”, the predicted value pred8×8_{L}[x, y] is generated according to the following expression (27).

$$\begin{matrix}[ Expression 1 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 27 )\end{matrix}$$

When p[x, −1] (x=0, . . . , 7) is “available” and p[−1, y] (y=0, . . . , 7) is “unavailable”, the predicted value pred8×8_{L}[x, y] is generated according to the following expression (28).

$$\begin{matrix}[ Expression 2 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 28 )\end{matrix}$$

When p[x, −1] (x=0, . . . , 7) is “unavailable” and p[−1, y] (y=0, . . . , 7) is “available”, the predicted value pred8×8_{L}[x, y] is generated according to the following expression (29).

$$\begin{matrix}[ Expression 3 ] & \\ Pred 8 \times {8}_{L} [ x , y ] = ( {\sum }_{{y}^{′} = 0}^{7} {P}^{′} [ - 1 , y ] + 4 ) >> 3 & ( 29 )\end{matrix}$$

When both p[x, −1] (x=0, . . . , 7) and p[−1, y] (y=0, . . . , 7) are “unavailable”, the predicted value pred8×8_{L}[x, y] is generated according to the following expression (30).

pred8×8_{L}[x,y]=128 (30) Expression (30) indicates the case of 8-bit input.

Mode 3 is a Diagonal_Down_Left_prediction mode, where the predicted value pred8×8_{L}[x, y] is generated as follows. Namely, the Diagonal_Down_Left_prediction mode is applied only when p[x, −1], x=0, . . . , 15 is “available”, and the predicted pixel value when x=7 and y=7 is generated according to the following expression (31), and the other predicted pixel values are generated according to the following expression (32).

pred8×8_{L}[x,y]=(p′[14,−1]+3*p[15,−1]+2)>>2 (31)

red8×8_{L}[x,y]=(p′[x+y,−1]+2*p′[x+y+1,−1]+p′[x+y+2,−1]+2)>>2 (32)

Mode 4 is a Diagonal_Down_Right_prediction mode, and the predicted value pred8×8_{L}[x, y] is generated as follows. Namely, the Diagonal_Down_Right_prediction mode is applied only when p[x, −1], x=0, . . . , 7 and p[−1, y], y=0, . . . , 7 are “available”. The predicted pixel value when x>y is generated according to the following expression (33), and the predicted pixel value when x<y is generated according to the following expression (34). The predicted pixel value when x=y is generated according to the following expression (35).

pred8×8_{L}[x,y]=(p′[x−y−2,−1]+2*p′[x−y−1,−1]+p′[x−y,−1]+2)>>2 (33)

pred8×8_{L}[x,y]=(p′[−1,y−x−2]+2*p′[−1,y−x−1]+p′[−1,y−x]+2)>>2 (34)

pred8×8_{L}[x,y]=(p′[0,−1]+2*p′[−1,−1]+p′[−1,0]+2)>>2 (35)

Mode 5 is a Vertical_Right_prediction mode where the predicted value pred8×8_{L}[x, y] is generated as follows. Namely, the Vertical_Right_prediction mode is applied only when p[x, −1], x=0, . . . , 7 and p[−1, y], y=−1, . . . , 7 are “available”. Now, zVR is defined by the following expression (36).

zVR=2*x−y (36)

At this time, when zVR is 0, 2, 4, 6, 8, 10, 12, or 14, the pixel predicted value is generated according to the following expression (37). When zVR is 1, 3, 5, 7, 9, 11, or 13, the pixel predicted value is generated according to the following expression (38).

pred8×8_{L}[x,y](p′[x−(y>>1)−1,−1]+p′[x−(y>>1),−1]+1)>>1 (37)

pred8×8_{L}[x,y]=(p′[x−(y>>1)−2,−1]+2*p′[x−(y>>1)−1,−1]+p′[x−(y>>1),−1]+2)>>2 (38)

When zVR is −1, the pixel predicted value is generated according to the following expression (39). In other cases, i.e., when zVR is −2, −3, −4, −5, −6, or −7, the pixel predicted value is generated according to the following expression (40).

pred8×8_{L}[x,y]=(p′[−1,0]+2*p′[−1,−1]+p′[0,−1]+2)>>2 (39)

pred8×8_{L}[x,y]=(p′[−1,y−2*x−1]+2*p′[−1,y−2*x−2]+p′[−1,y−2*x−3]+2)>>2 (40)

Mode 6 is a Horizontal_Down_prediction mode where the predicted value pred8×8_{L}[x, y] is generated as follows. Namely, the Horizontal_Down_prediction mode is applied only when p[x, −1], x=0, . . . , 7 and p[−1, y], y=−1, . . . , 7 are “available”. Now, zVR is defined by the following expression (41).

zHD=2*y−x (41)

At this time, when zHD is 0, 2, 4, 6, 8, 10, 12, or 14, the predicted pixel value is generated according to the following expression (42). When zHD is 1, 3, 5, 7, 9, 11, or 13, the predicted pixel value is generated according to the following expression (43).

pred8×8_{L}[x,y]=(p′[−1,y−(x>>1)−1]+p′[−1,y−(x>>1)+1]>>1 (42)

pred8×8_{L}[x,y]=(p′[−,y−(x>>1)−2]+2*p′[−1,y−(x>>1)−1]+p′[−1,y−(x>>1)]+2)>>2 (43)

When zHD is −1, the predicted pixel value is generated according to the following expression (44). When zHD has other values; namely, −2, −3, −4, −5, −6, or −7, the predicted pixel value is generated according to the following expression (45).

pred8×8_{L}[x,y]=(p′[−1,0]+2*p[−1,−1]+p′[0,−1]+2)>>2 (44)

pred8×8_{L}[x,y]=(p′[x−2*y−1,−1]+2*p′[x−2*y−2,−1]+p′[x−2*y−3,−1]+2)>> (45)

Mode 7 is a Vertical_Left_prediction mode, where the predicted value pred8×8_{L}[x, y] is generated as follows. Namely, the Vertical_Left_prediction mode is applied only when p[x, −1], x=0, . . . , 15 is “available”. When y=0, 2, 4, or 6, the predicted pixel value is generated according to the following expression (46). In other cases, that is when y=1, 3, 5, or 7, the predicted pixel value is generated according to the following expression (47).

pred8×8_{L}[x,y]=(p′[x+(y>>1),−1]+p′[x+(y>>1)+1,−1]+1)>>1 (46)

pred8×8_{L}[x,y]=(p′[x+(y>>1),−1]2*p′[x+(y>>1)+1,−1]+p′[x+(y>>1)+2,−1]+2)>>2 (47)

Mode 8 is a Horizontal_Up_prediction mode, where the predicted value pred8×8_{L}[x, y] is generated as follows. Namely, the Horizontal_Up_prediction mode is applied only when p[−1, y], y=0, . . . , 7 is “available”. In the following, zHU is defined by the following expression (48).

zHU=x+2*y (48)

When the value of zHU is 0, 2, 4, 6, 8, 10, or 12, the predicted pixel value is generated according to the following expression (49). When the value of zHU is 1, 3, 5, 7, 9, or 11, the predicted pixel value is generated according to the following expression (50).

pred8×8_{L}[x,y]=(p′[−1,y+(x>>1)]+p′[−1,y+(x>>1)+1]+1)>>1 (49)

pred8x8_{L}[x,y]=(p′[−1,y+(x>>1)] (50)

When the value of zHU is 13, the predicted pixel value is generated according to the following expression (51). In other cases, namely when the value of zHU is greater than 13, the predicted pixel value is generated according to the following expression (52).

pred8×8_{L}[x,y]=(p′[−1,6]+3*p′[−1,7]+2)>>2 (51)

pred8×8_{L}[x,y]=p′[−1,7] (52)

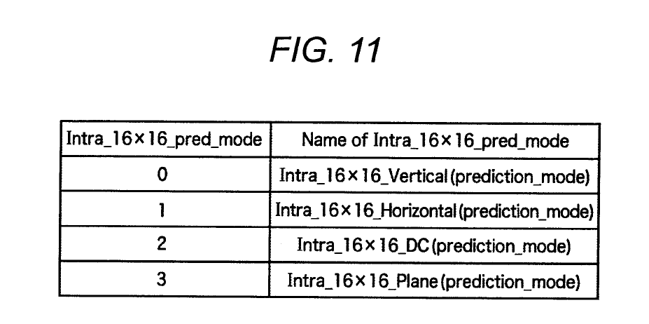

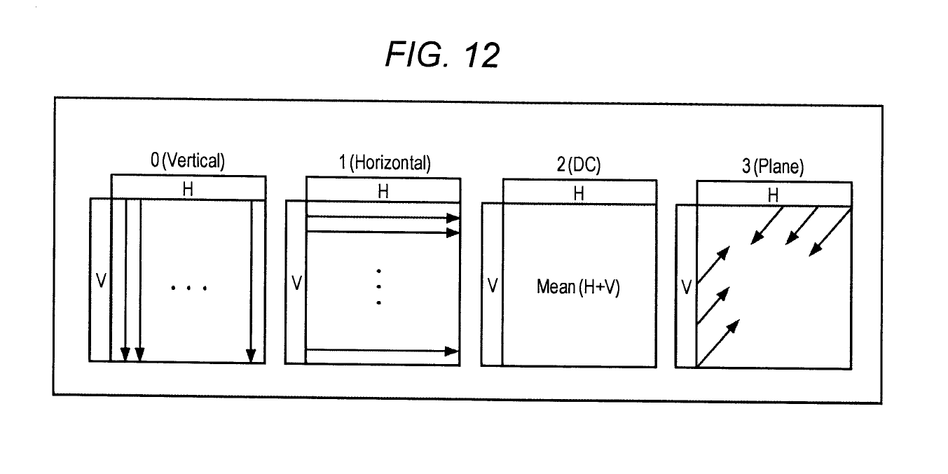

Next, a 16×16 pixel intra prediction mode will be described. FIGS. 11 and 12 illustrate four types of 16×16 pixel intra prediction modes (Intra_{—}16×16_pred_mode) for the luminance signal.

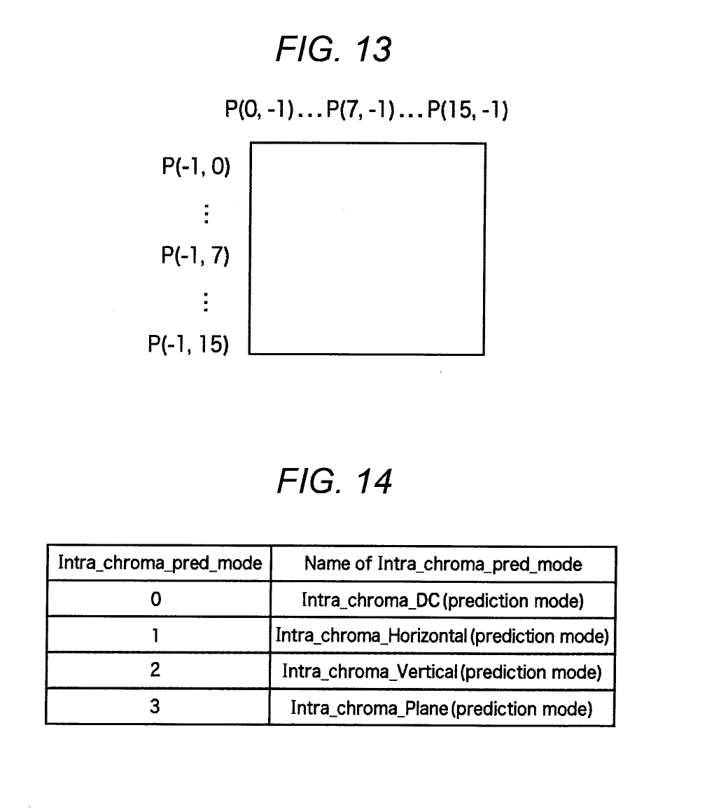

The four types of intra prediction modes will be described with reference to FIG. 13. In the example of FIG. 13, a current macroblock A subjected to intra processing is illustrated, where P(x, y); x, y=−1, 0, . . . , 15 represents the pixel value of a pixel adjacent the current macroblock A.

Mode 0 is a Vertical Prediction mode which is applied only when P(x, −1); x, y=−1, 0, . . . , 15 is “available”. In this case, the predicted pixel value Pred(x, y) of each of the pixels of the current macroblock A is generated according to the following expression (53).

Pred(x,y)=P(x,−1);x,y=0, . . . , 15 (53)

Mode 1 is a Horizontal Prediction mode which is applied only when P(−1, y); x, y=−1, 0, . . . , 15 is “available”. In this case, the predicted pixel value Pred(x, y) of each of the pixels of the current macroblock A is generated according to the following expression (54).

Pred(x,y)=P(−1,y);x,y=0, . . . , 15 (54)

Mode 2 is a DC Prediction mode where, when all of P(x, −1) and P(−1, y); x, y=−1, 0, . . . , 15 are “available”, the predicted pixel value Pred(x, y) of each of the pixels of the current macroblock A is generated according to the following expression (55).

$$\begin{matrix}[ Expression 4 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 55 )\end{matrix}$$

When P(x, −1); x, y=−1, 0, . . . , 15 is “unavailable”, the predicted pixel value Pred(x, y) of each of the pixels of the current macroblock A is generated according to the following expression (56).

$$\begin{matrix}[ Expression 5 ] & \\ Pred ( x , y ) = [ {\sum }_{{y}^{′} = 0}^{15} P ( - 1 , {y}^{′} ) + 8 ] >> 4 with x , y = 0 , … , 15 & ( 56 )\end{matrix}$$

When P(−1, y); x, y=−1, 0, . . . , 15 is “unavailable”, the predicted pixel value Pred(x, y) of each of the pixels of the current macroblock A is generated according to the following expression (57).

$$\begin{matrix}[ Expression 6 ] & \\ Pred ( x , y ) = [ {\sum }_{{y}^{′} = 0}^{15} P ( {x}^{′} , - 1 ) + 8 ] >> 4 with x , y = 0 , … , 15 & ( 57 )\end{matrix}$$

When all of P(x, −1) and P(−1, y); x, y=−1, 0, . . . , 15 are “unavailable”, 128 is used as the predicted pixel value.

Mode 3 is a Plane Prediction mode and is applied only when all of P(x, −1) and P(−1, y); x, y=−1, 0, . . . , 15 are “available”. In this case, the predicted pixel value Pred(x, y) of each of the pixels of the current macroblock A is generated according to the following expression (58).

$$\begin{matrix}[ Expression 7 ] & \\ \begin{matrix}Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) )\end{matrix} & ( 58 )\end{matrix}$$

Next, an intra prediction mode for the chrominance signal will be described. FIG. 14 illustrates four types of intra prediction modes for the chrominance signal (Intra_chroma_pred_mode). The intra prediction mode for the chrominance signal can be set independently from the intra prediction mode for the luminance signal. The intra prediction mode for the chrominance signal may be in accord with the above-described 16×16 pixel intra prediction mode for the luminance signal.

However, while the 16×16 pixel intra prediction mode for the luminance signal is intended for a 16×16 pixel block, the intra prediction mode for the chrominance signal is intended for a 8×8 pixel block. Further, as illustrated in the above-described FIGS. 11 and 14, their mode numbers do not correspond to each other.

Here, the definitions of the pixel values of the current macroblock A and the adjacent pixel values in the 16×16 pixel intra prediction mode for the luminance signal described with reference to FIG. 13 are followed. For example, the pixel value of a pixel adjacent the current macroblock A (8×8 pixels in the case of the chrominance signal) subjected to intra processing is P(x, y); x, y=−1, 0, . . . , 7.

Mode 0 is a DC Prediction mode where, when all of P(x, −1) and P(−1, y); x, y=−1, 0, . . . , 7 are “available”, the predicted pixel value Pred(x, y) of each of the pixels of the current macroblock A is generated according to the following expression (59).

$$\begin{matrix}[ Expression 8 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 59 )\end{matrix}$$

When P(−1, y); x, y=−1, 0, . . . , 7 is “unavailable”, the predicted pixel value Pred(x, y) of each of the pixels of the current macroblock A is generated according to the following expression (60).

$$\begin{matrix}[ Expression 9 ] & \\ Pred ( x , y ) = [ ( {\sum }_{n = 0}^{7} P ( n , - 1 ) ) + 4 ] >> 3 with x , y = 0 , … , 7 & ( 60 )\end{matrix}$$

When P(x, −1); x, y=−1, 0, . . . , 7 is “unavailable”, the predicted pixel value Pred(x, y) of each of the pixels of the current macroblock A is generated according to the following expression (61).

$$\begin{matrix}[ Expression 10 ] & \\ Pred ( x , y ) = [ ( {\sum }_{n = 0}^{7} P ( - 1 , n ) ) + 4 ] >> 3 with x , y = 0 , … , 7 & ( 61 )\end{matrix}$$

Mode 1 is a Horizontal Prediction mode which is applied only when P(−1, y); x, y=−1, 0, . . . , 7 is “available”. In this case, the predicted pixel value Pred(x, y) of each of the pixels of the current macroblock A is generated according to the following expression (62).

Pred(x,y)=P(−1,y);x,y=0, . . . , 7 (62)

Mode 2 is a Vertical Prediction mode which is applied only when P(x, −1); x, y=−1, 0, . . . , 7 is “available”. In this case, the predicted pixel value Pred(x, y) of each of the pixels of the current macroblock A is generated according to the following expression (63).

Pred(x,y)=P(x,−1);x,y=0, . . . , 7 (63)

Mode 3 is a Plane Prediction mode which is applied only when P(x, −1) and P(−1, y); x, y=−1, 0, . . . , 7 are “available”. In this case, the predicted pixel value Pred(x, y) of each of the pixels of the current macroblock A is generated according to the following expression (64).

$$\begin{matrix}[ Expression 11 ] & \\ \begin{matrix}Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ]\end{matrix} & ( 64 )\end{matrix}$$

Thus, the intra prediction mode for the luminance signal includes nine types of prediction modes of 4×4 pixel and 8×8 pixel block units and four types of prediction units of 16×16 pixel macroblock units. This block unit mode is set on a macroblock unit basis. The intra prediction mode for the chrominance signal includes four types of prediction modes of the 8×8 pixel block units. The intra prediction modes for the chrominance signal may be set independently from the intra prediction mode for the luminance signal.

As regards the 4×4 pixel intra prediction mode (intra 4×4 prediction mode) and the 8×8 pixel intra prediction mode (intra 8×8 prediction mode) for the luminance signal, one intra prediction mode is set for each of the 4×4 pixel and 8×8 pixel blocks for the luminance signal. As regards the 16×16 pixel intra prediction mode (intra 16×16 prediction mode) for the luminance signal and the intra prediction mode for the chrominance signal, one prediction mode is set for one macroblock.

The types of prediction mode correspond to the directions indicated by the numbers 0, 1, 3 through 8 in FIG. 5. The prediction mode 2 is for average value prediction.

Thus, during intra prediction in the H.264/AVC scheme, as described with reference to expressions (14) through (24), a filter process is performed on the pixel values of the adjacent pixels using the determined filter coefficients only prior to performing intra prediction in the 8×8 pixel block unit.

### Detailed Configuration Examples

In the image coding apparatus 51 of FIG. 2, when intra prediction is performed, adjacent pixel values corresponding to a plurality of lines are stored in the line buffer, and intra prediction is performed by using the stored values.

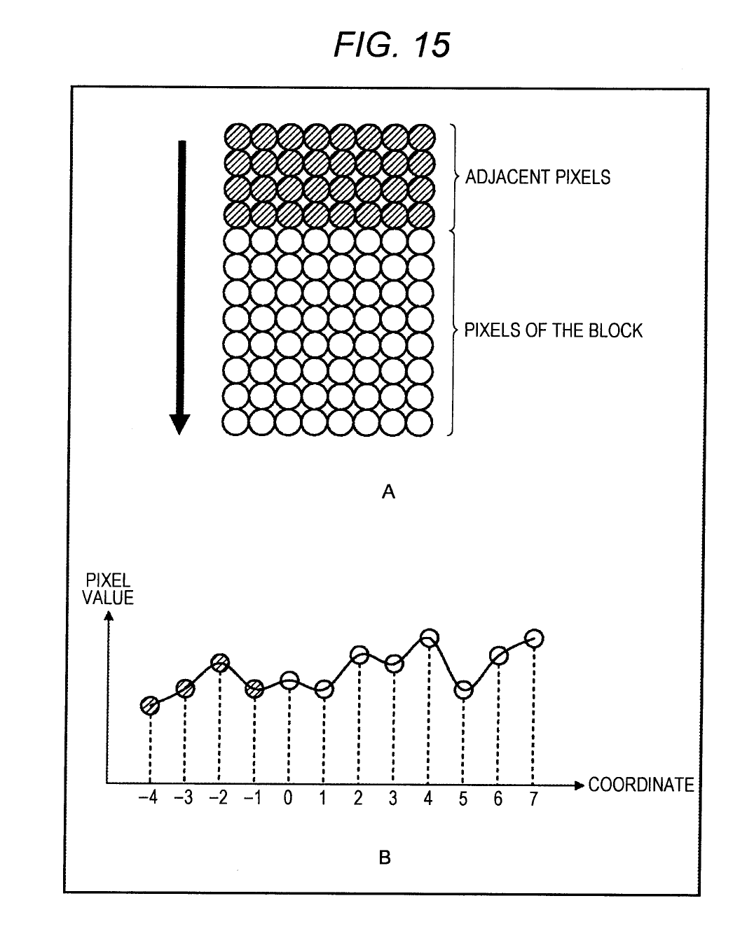

With reference to FIG. 15, intra prediction in the image coding apparatus 51 will be described. FIG. 15A illustrates a Vertical Prediction method in a case where the size of the block is 8×8 pixels. The white circles represent the pixels of the block, and the circles with hatching represent the adjacent pixels used for Vertical Prediction.

Specifically, while in the case of the H.264/AVC scheme, intra prediction uses the adjacent pixels of only one line, the adjacent pixels of a plurality of lines (such as four lines in the case of FIG. 15A) are used in the image coding apparatus 51.

FIG. 15B illustrates each of the vertical lines of FIG. 15A as seen in the direction of arrow. In the example, the pixel value at each position is defined as P(x); x=−4, . . . , −1, 0, . . . , 7. Namely, x=−4 through −1 indicate the pixel values of the adjacent pixels, while x=0 through 7 indicate the pixel values of the pixels of the block. Thus, P(x) for the pixel value of an adjacent pixel is a known value, while the pixel value of a pixel of the block is a predicted value; namely, an unknown value. In the image coding apparatus 51, the unknown value is determined from the known value.

It is now supposed that P(x) in FIG. 15B is approximated by a polynomial according to the following expression (65).

[Expression 12]

P(x)=ax³+bx²+cx+d (65)

The values of parameters a, b, c, and d in the expression (65) can be calculated by solving simultaneous equations according to the following expression (66).

[Expression 13]

P(−4)=a*(−4)³+b*(−4)²+c*(−4)+d

P(−3)=a*(−3)³+b*(−3)²+c*(−3)+d

P(−2)=a*(−2)³+b*(−2)²+c*(−2)+d

P(−1)=a*(−1)³+b*(−1)²+c*(−1)+d (66)

By calculating P(0) through P(7) by using the parameters a, b, c, and d according to the expression (66) in the expression (65), the predicted pixel values for the block can be obtained. Specifically, in this case, when the adjacent pixels of 4 lines are used, four constants of a third-degree polynomial are calculated by solving four simultaneous equations, and an intra predicted image is generated by the third-degree polynomial having the four constants. Namely, the third-degree polynomial having the four calculated constants can be said to be a polynomial that approximates the adjacent pixels of the four lines and the eight pixels of the block, as illustrated in FIG. 15B.

Because P(0) through P(7) are pixel values, a process of clipping the values in a range of 0 to 2^{N}−1 needs to be performed when the input image signal has N bits.

Further, as regards the parameters a, b, c, and d, the same values can be calculated by performing a similar process on the decoding side, so that the parameters need not be added to the header of the compressed image for transmission.

Thus, in the image coding apparatus 51, the intra predicted image is generated by performing an extrapolation process based on polynomial approximation using the adjacent pixels of a plurality of lines. This extrapolation process by polynomial approximation is a process performed by the intra prediction unit 73 and the spline interpolation unit 75 and may be referred to as “spline interpolation”. In the following, the parameters a, b, c, and d may be referred to as “spline parameters” or “interpolation parameters”.

In this way, intra prediction accuracy and coding efficiency can be improved.

While an example of Vertical Prediction has been described, a similar process may be applied to all intra prediction modes other than the DC Prediction by performing the process along the directions illustrated in FIG. 6. The process may also be applied to the chrominance signal in addition to the luminance signal. The number of lines used for the chrominance signal may be smaller, or the same as, the number of lines used for the luminance signal.

While in the example of FIG. 15 the pixels used for intra prediction are the pixels of four lines, the number of the lines is not limited to four and may be two or more. Namely, when N lines of adjacent pixels are used, N constants of a N−1 degree polynomial is calculated by solving N simultaneous equations, and an intra predicted image is generated by using the N−1 degree polynomial having the N constants. Preferably, a larger number of lines may be used depending on the size of the block.

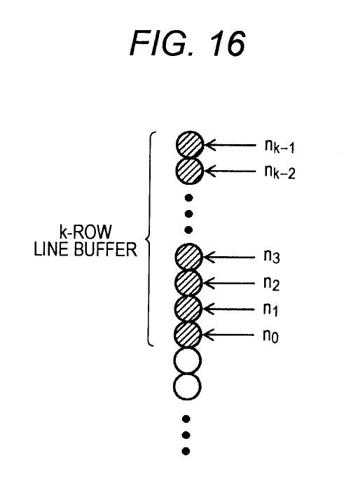

It is now supposed that k rows of line buffers are provided for performing intra prediction according to the present invention, as illustrated in FIG. 16.

When the adjacent pixels and the pixels of the block do not include an object boundary, higher prediction accuracy may be obtained by performing approximation using a higher-degree polynomial involving all of the pixels of the k rows.

However, when an object boundary is included in the adjacent pixels of the k rows, performing a polynomial approximation process exceeding the boundary may result in a decrease in prediction efficiency.

Thus, in accordance with the present invention, it is determined up to which of the k rows of line buffers provided in the line buffer 74 are to be used, by the following method. Namely, first, difference values |n₀−n₁|, |n₁−n₂|, . . . between adjacent ones of the adjacent pixels are calculated.

When the following expression (67) is valid with respect to the pixel value n₃, it can be thought that an object boundary exists between the pixels n₂ and n₃.

[Expression 14]

|n₃−n₂|>|n₂−n₁|+θ

and

|n₃−n₂|>|n₁−n₀|+θ (67)

where Θ is a threshold value determined by the user.

In this case, higher prediction efficiency may be obtained by second-degree polynomial approximation using n₀, n₁, and n₂ than by polynomial approximation using pixel values of n₃ and subsequent pixel values.

Namely, a determination as to whether the following expression (68) is valid is made with respect to the pixel nₕ where h≧3. If it is valid, intra prediction by k−1 degree polynomial approximation is performed by using only the pixel values closer to the block than the pixel nₕ.

[Expression 15]

|nₕ−nₕ₋₁|>|nₕ₋₁−nₕ₋₂═+θ

and

|nₕ−nₕ₋₁|>|nₕ₋₂−nₕ₋₃|+θ (68)

Here, larger values of Θ are set for a greater quantization parameter. This is because, when coding is performed with a greater quantization parameter, the value of |nₕ−nₕ₋₁| may be increased not only due to the object boundary but also due to quantization error.

Thus, when it can be thought that no object boundary is included, improved accuracy may be obtained by increasing the number of lines. However, this may result in cost increase when the number of lines of the line memory is also increased accordingly.

A process similar to the process of determining what degree polynomial is to be used may be performed on the decoding side. Thus, this information may not be transmitted.

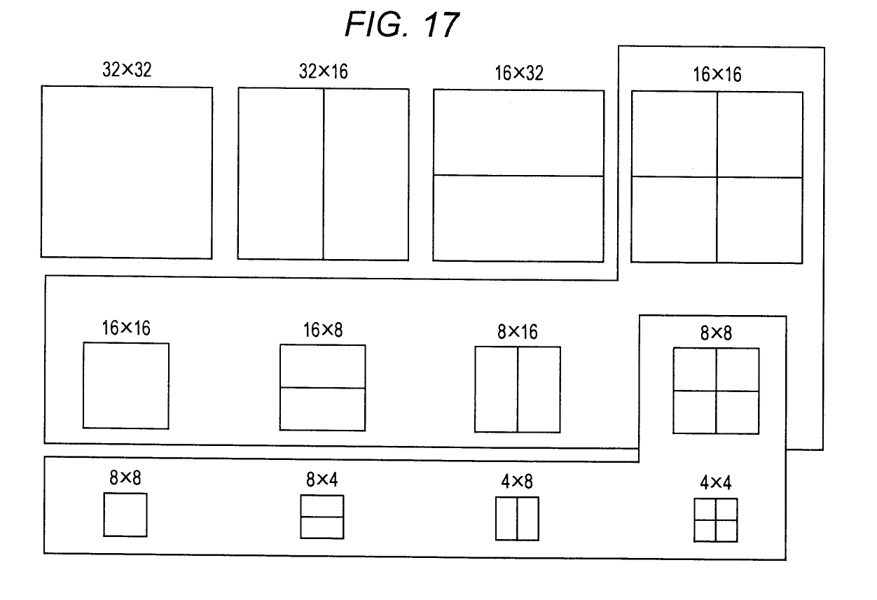

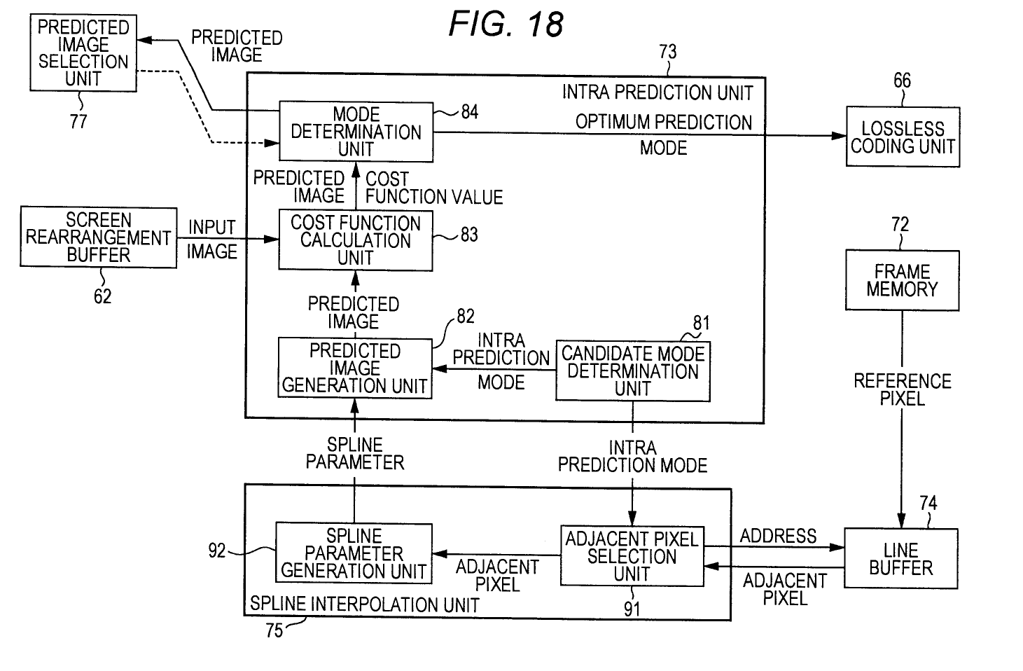

While the above example has been described with reference to the 8×8 pixel block, the range of application of the present invention is not limited thereto and the present invention may be applied to pixel blocks of any size. For example, the present invention may be applied to an extended macroblock illustrated in FIG. 17.

FIG. 17 illustrates examples of block size proposed in Non-Patent Document 1 or 2. In Non-Patent Document 1 or 2, the macroblock size is extended to 32×32 pixels.

At the top of FIG. 17, macroblocks including 32×32 pixels partitioned into blocks (partitions) of 32×32 pixels, 32×16 pixels, 16×32 pixels, and 16×16 pixels are illustrated in order from left. In the middle of FIG. 17, blocks including 16×16 pixels partitioned into blocks of 16×16 pixels, 16×8 pixels, 8×16 pixels, and 8×8 pixels are illustrated in order from left. At the bottom of FIG. 17, 8×8 pixel blocks partitioned into blocks of 8×8 pixels, 8×4 pixels, 4×8 pixels, and 4×4 pixels are illustrated in order from left.

Namely, the 32×32 pixel macroblock can be processed in blocks of 32×32 pixels, 32×16 pixels, 16×32 pixels, and 16×16 pixels illustrated at the top of FIG. 17.

The 16×16 pixel block illustrated at top-right may be processed in blocks of 16×16 pixels, 16×8 pixels, 8×16 pixels, and 8×8 pixels illustrated in the middle, as in the H.264/AVC scheme.

The 8×8 pixel block illustrated at middle-right may be processed in the blocks of 8×8 pixels, 8×4 pixels, 4×8 pixels, and 4×4 pixels illustrated at bottom, as in the H.264/AVC scheme.

These blocks may be categorized into the following three layers. Namely, the blocks of 32×32 pixels, 32×16 pixels, and 16×32 pixels at top of FIG. 17 may be referred to as a first layer. The 16×16 pixel block at top-right and the blocks of 16×16 pixels, 16×8 pixels, and 8×16 pixels in middle may be referred to as a second layer. The 8×8 pixel block in middle-right and the blocks of 8×8 pixels, 8×4 pixels, 4×8 pixels, and 4×4 pixels at bottom may be referred to as a third layer.

By adopting the hierarchical structure as illustrated in FIG. 17, with respect to the 16×16 pixel block and smaller blocks, larger blocks are defined as their super set while maintaining compatibility with the macroblock in the current AVC.

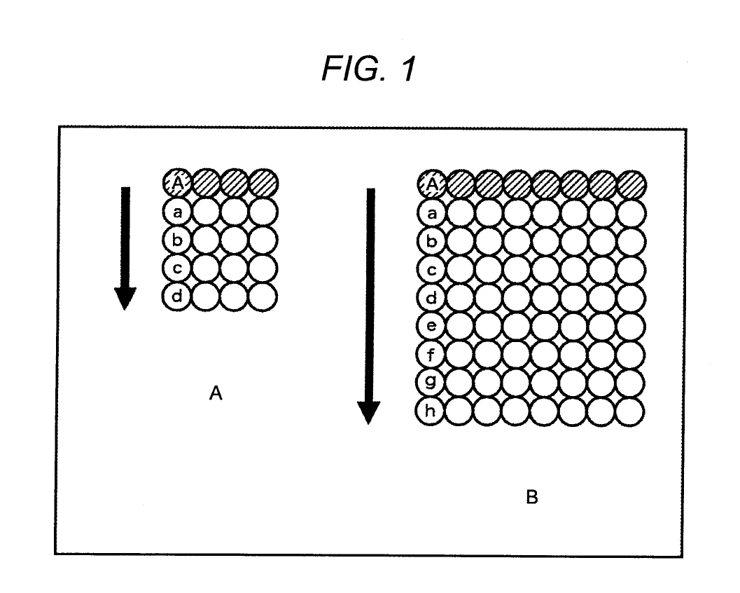

Thus, according to the present invention, particularly in the extended macroblock illustrated in FIG. 17, prediction accuracy with respect to the larger intra prediction block described above with reference to FIG. 1 can be improved.

### [Example of Configuration of Intra Prediction Unit and Spline Interpolation Unit]

FIG. 18 is a block diagram of an example of a detailed configuration of the intra prediction unit 73 and the spline interpolation unit 75 for performing the above-described intra prediction.

In the example of FIG. 18, the intra prediction unit 73 includes a candidate mode determination unit 81, a predicted image generation unit 82, a cost function calculation unit 83, and a mode determination unit 84. The spline interpolation unit 75 includes an adjacent pixel selection unit 91 and a spline parameter generation unit 92.

The candidate mode determination unit 81 supplies, of all or some of the intra prediction modes defined in a coding scheme, one or more candidate modes in the block which are “available”, to the adjacent pixel selection unit 91 and the predicted image generation unit 82. “Available” indicates that the adjacent pixels used in the particular mode can be utilized.

The predicted image generation unit 82 generates a predicted image of the intra prediction mode from the candidate mode determination unit 81 by using a spline parameter from the spline parameter generation unit 92. Specifically, the predicted image generation unit 82 generates the predicted image by calculating P(0) through P(7) by using the N spline parameters determined by the expression (66) in the N−1 degree polynomial according to the expression (65). The generated predicted image is supplied to the cost function calculation unit 83.

The cost function calculation unit 83 receives the pixel values of an input image from the screen rearrangement buffer 62 and calculates cost function values for all of the candidate modes on the basis of the input image pixel values and the predicted image from the predicted image generation unit 82. The cost function calculation unit 83 supplies the predicted image and the cost function value for each candidate mode to the mode determination unit 84.

The mode determination unit 84 determines one of the candidate prediction modes that has the minimum cost function value as an optimum prediction mode for the block, and supplies the corresponding predicted image and cost function value to the predicted image selection unit 77. When the predicted image for intra prediction is selected in the predicted image selection unit 77, relevant information is supplied from the predicted image selection unit 77. Thus, the mode determination unit 84 supplies the information of the optimum prediction mode to the lossless coding unit 66.

The line buffer 74 receives and stores all of the adjacent pixels that may possibly be used for intra prediction from the frame memory 72. The adjacent pixel selection unit 91 determines which of the adjacent pixels are to be used depending on the candidate intra prediction mode from the candidate mode determination unit 81, and supplies the addresses of the selected adjacent pixels to the line buffer 74. The values of the adjacent pixels are supplied from the line buffer 74 to the adjacent pixel selection unit 91 on the basis of these addresses. The adjacent pixel selection unit 91 supplies the supplied values of the adjacent pixels to the spline parameter generation unit 92.

The spline parameter generation unit 92 calculates the N spline parameters of the N−1 degree polynomial for intra prediction by solving N simultaneous equations according to the expression (66) using the adjacent pixel values of N lines, and supplies the N calculated spline parameters to the predicted image generation unit 82.

### [Description of Coding Process in Image Coding Apparatus]

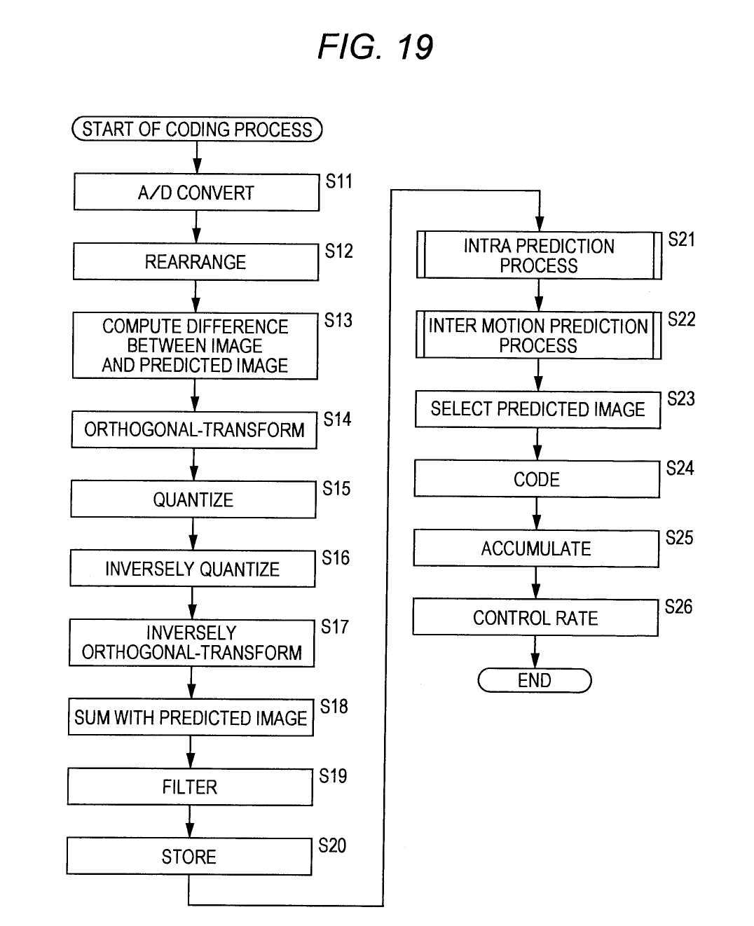

Next, a coding process in the image coding apparatus 51 of FIG. 1 will be described with reference to a flowchart of FIG. 19.

In step S11, the A/D conversion unit 61 subjects the input image to A/D conversion. In step S12, the screen rearrangement buffer 62 stores the image supplied from the A/D conversion unit 61, and rearranges the order of display of pictures into an order of coding.

In step S13, the arithmetic unit 63 calculates a difference between the image rearranged in step S12 and the predicted image. The predicted image is supplied from the motion prediction/compensation unit 76 when inter prediction is performed or from the intra prediction unit 73 when intra prediction is performed, to the arithmetic unit 63 via the predicted image selection unit 77.

The difference data has a decreased data amount compared to the original image data. Therefore, the amount of data can be compressed compared to the case when the image is coded as is.

In step S14, the orthogonal transform unit 64 subjects the difference information supplied from the arithmetic unit 63 to orthogonal transform. Specifically, orthogonal transform such as discrete cosine transform or Karhunen-Loève Transform is performed, and a transform coefficient is output. In step S15, the quantization unit 65 quantizes the transform coefficient. During this quantization, the rate is controlled in a process of step S25, as will be described later.

The quantized difference information is decoded locally as follows. Namely, in step S16, the inverse quantization unit 68 inversely quantizes the transform coefficient quantized by the quantization unit 65 in accordance with characteristics corresponding to the characteristics of the quantization unit 65. In step S17, the inverse orthogonal transform unit 69 subjects the transform coefficient inversely quantized by the inverse quantization unit 68 to inverse orthogonal transform in accordance with characteristics corresponding to the characteristics of the orthogonal transform unit 64.

In step S18, the arithmetic unit 70 sums the predicted image input via the predicted image selection unit 77 with the locally decoded difference information, thereby generating a locally decoded image (image corresponding to the input to the arithmetic unit 63). In step S19, the deblocking filter 71 filters the image output from the arithmetic unit 70. As a result, block distortion is removed. In step S20, the frame memory 72 stores the filtered image. The image that is not filtered by the deblocking filter 71 is also supplied from the arithmetic unit 70 and stored in the frame memory 72.

When the process target image supplied from the screen rearrangement buffer 62 includes an image of a block for intra process, a decoded image that is referenced is read from the frame memory 72 and supplied to the line buffer 74.

On the basis of these images, the intra prediction unit 73 and the spline interpolation unit 75 in step S21 subjects the pixels of the process current block to intra prediction in all of the candidate intra prediction modes by an extrapolation process using polynomial approximation (i.e., spline interpolation process). As the decoded pixels that are referenced, the pixels that are not subjected the deblocking filtering by the deblocking filter 71 are used.

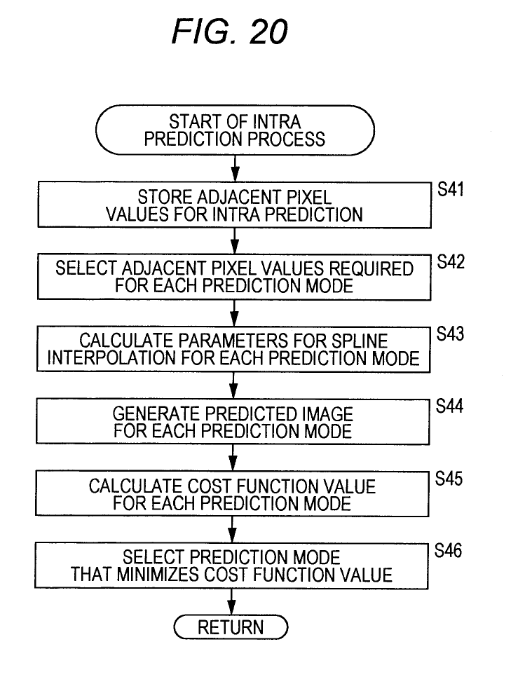

The details of the intra prediction process in step S21 will be described later with reference to FIG. 20. By this process, intra prediction is performed in all of the candidate intra prediction modes, and the cost function values are calculated for all of the candidate intra prediction modes. On the basis of the calculated cost function values, the optimum intra prediction mode is selected, and the predicted image generated by intra prediction in the optimum intra prediction mode and the corresponding cost function value are supplied to the predicted image selection unit 77.

When the process target image supplied from the screen rearrangement buffer 62 includes an image for inter process, the reference image is read from the frame memory 72 and supplied to the motion prediction/compensation unit 76. On the basis of these images, the motion prediction/compensation unit 76 in step S22 performs an inter motion prediction process.

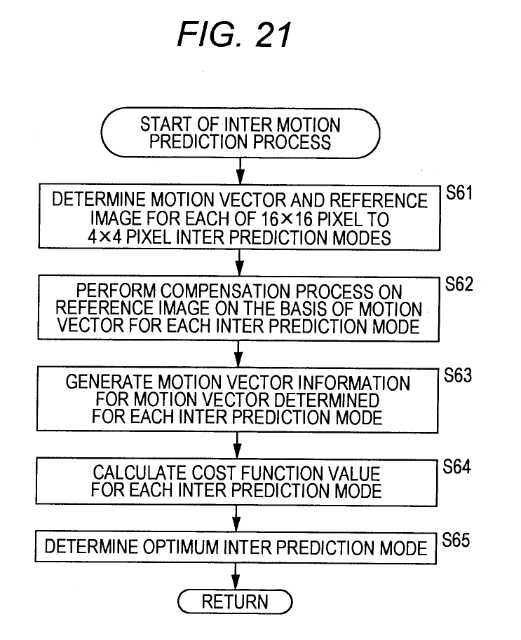

The details of the inter motion prediction process in step S22 will be described later with reference to FIG. 21. By this process, a motion search process is performed in all of the candidate inter prediction modes, and the cost function value is calculated for all of the candidate inter prediction modes. On the basis of the calculated cost function values, the optimum inter prediction mode is determined. Then, the predicted image generated in the optimum inter prediction mode and the corresponding cost function value are supplied to the predicted image selection unit 77.

In step S23, the predicted image selection unit 77, on the basis of the cost function values output from the intra prediction unit 73 and the motion prediction/compensation unit 76, determines one of the optimum intra prediction mode and the optimum inter prediction mode as the optimum prediction mode. Then, the predicted image selection unit 77 selects the predicted image of the determined optimum prediction mode and supplies it to the arithmetic units 63 and 70. This predicted image is utilized for the operations in steps S13 and S18 as described above.

Selection information about the predicted image is supplied to the intra prediction unit 73 or the motion prediction/compensation unit 76. When the predicted image of the optimum intra prediction mode is selected, the intra prediction unit 73 supplies information indicating the optimum intra prediction mode (i.e., intra prediction mode information) to the lossless coding unit 66.

When the predicted image of the optimum inter prediction mode is selected, the motion prediction/compensation unit 76 outputs information indicating the optimum inter prediction mode and, if necessary, information corresponding to the optimum inter prediction mode to the lossless coding unit 66. The information corresponding to the optimum inter prediction mode may include motion vector information or reference frame information.

In step S24, the lossless coding unit 66 codes the quantized transform coefficient output from the quantization unit 65. Specifically, the difference image is lossless-coded by variable length coding or arithmetic coding, for example, and compressed. At this time, the intra prediction mode information input to the lossless coding unit 66 from the intra prediction unit 73 in step S21, or the information corresponding to the optimum inter prediction mode from the motion prediction/compensation unit 76 in step S22, may also be coded and added to the header information.

For example, the information indicating the intra prediction mode or the information indicating the inter prediction mode is coded on a macroblock basis.

The motion vector information and the reference frame information are coded on a current block basis.

In step S25, the accumulation buffer 67 accumulates the difference image as a compressed image. The compressed image accumulated in the accumulation buffer 67 is read as needed and transmitted to the decoding side via a transmission path.

In step S26, the rate control unit 78, on the basis of the compressed image accumulated in the accumulation buffer 67, controls the rate of quantizing operation in the quantization unit 65 so that no overflow or underflow is generated.

### [Description of Intra Prediction Process]

Next, the intra prediction process in step S21 of FIG. 19 will be described with reference to a flowchart of FIG. 20, illustrating an example in the case of the luminance signal.

When the process target image supplied from the screen rearrangement buffer 62 includes an image of a block to be intra-processed, the decoded image that is referenced for intra prediction is read from the frame memory 72 and supplied to the line buffer 74.

In step S41, the line buffer 74 stores the supplied adjacent pixel values for intra prediction.

The candidate mode determination unit 81 supplies, of all or some of the intra prediction modes defined in the coding scheme, one or more candidate modes in the block that are “available”, to the adjacent pixel selection unit 91 and the predicted image generation unit 82. For example, the intra prediction modes of 4×4 pixels, 8×8 pixels, and 16×16 pixels described above with reference to FIGS. 4 through 14 are candidate modes.

In response, the adjacent pixel selection unit 91 in step S42 determines which of the adjacent pixels are to be used in accordance with the candidate intra prediction modes from the candidate mode determination unit 81 and supplies the corresponding addresses to the line buffer 74. The values of the adjacent pixels are supplied from the line buffer 74 to the adjacent pixel selection unit 91 by using the addresses, and the adjacent pixel selection unit 91 supplies the values of the supplied adjacent pixels to the spline parameter generation unit 92.

In step S43, the spline parameter generation unit 92 calculates the N spline parameters in the N−1 degree polynomial for each of the prediction modes by solving N simultaneous equations according to the expression (66), and supplies the calculated spline parameters to the predicted image generation unit 82.

In step S44, the predicted image generation unit 82 generates the predicted image for each of the modes by using the spline parameters from the spline parameter generation unit 92. Specifically, the predicted image is generated by calculating P(0) through P(7) by using the N spline parameters in the N−1 degree polynomial of the expression (65). The generated predicted image is supplied to the cost function calculation unit 83.

In step S45, the cost function calculation unit 83 receives the pixel values of the input image from the screen rearrangement buffer 62, and calculates the cost function value for each prediction mode by using the pixel values of the input image from the screen rearrangement buffer 62 and the predicted image from the predicted image generation unit 82. The cost function calculation unit 83 supplies the predicted image and cost function value for each candidate mode to the mode determination unit 84.

The cost function value may be determined by a High Complexity Mode method or a Low Complexity Mode method. In the H.264/AVC scheme, a method is used in which one of the two mode determination methods, i.e., the High Complexity Mode or the Low Complexity Mode which are determined by JM, is selected. In this method, in either mode, a cost function value for each of the prediction modes is calculated, and a prediction mode that minimizes the cost function value is selected as an optimum mode for the block or macroblock.

The cost function value in the High Complexity Mode may be determined according to the following expression (69).

Cost(ModeεΩ)=D+λ×R (69)

In the expression (69), Ω is a universal set of candidate modes for coding the block or macroblock; D is a difference energy between the decoded image and the input image when coded in the particular prediction mode Mode; λ is a Lagrange's undetermined multiplier given as a quantization parameter function; and R is a total coding amount when coded in the mode Mode that includes an orthogonal transform coefficient.

Namely, in order to perform coding in the High Complexity Mode, a provisional encoding process needs to be performed so as to calculate the parameters D and R in all of the candidate modes Mode, thus requiring greater amounts of computation.

On the other hand, the cost function value in the Low Complexity Mode may be determined by the following expression (70).

Cost(ModeεΩ)=D+QP2Quant(QP)×HeaderBit (70)

In the expression (70), D is a difference energy between the predicted image and the input image, as opposed to the High Complexity Mode; QP2Quant(QP) is given as a function of a quantization parameter QP; and HeaderBit is a coding amount concerning information belonging to the header, such as motion vector and mode, that do not include the orthogonal transform coefficient.

Namely, in the Low Complexity Mode, while a prediction process needs to be performed for each of the candidate modes Mode, no decoded image is required, so that no coding process needs to be performed. Thus, coding in the Low Complexity Mode can be realized with less amounts of computation than in the High Complexity Mode.

In step S46, the mode determination unit 84 selects one of the candidate prediction modes that minimizes the cost function value as an optimum prediction mode for the block, and supplies the corresponding predicted image and cost function value to the predicted image selection unit 77.

Then, in the above-described step S23 of FIG. 19, when the predicted image generated in the optimum intra prediction mode is selected by the predicted image selection unit 77, information indicating the optimum intra prediction mode is supplied from the mode determination unit 84 to the lossless coding unit 66. The lossless coding unit 66 codes the information and adds it to the header information of the compressed image (as described above in step S24 of FIG. 19).

### [Description of Inter Motion Prediction Process]

Next, the inter motion prediction process in step S22 of FIG. 19 will be described with reference to a flowchart of FIG. 21.

The motion prediction/compensation unit 76 in step S61 determines a motion vector and a reference image for each of eight types of inter prediction modes including 16×16 through 4×4 pixels. Namely, a motion vector and a reference image are determined for each of the process current blocks of the inter prediction modes.

The motion prediction/compensation unit 76 in step S62 performs a motion prediction and compensation process on the reference image on the basis of the motion vector determined in step S61 with regard to each of the eight types of inter prediction modes having 16×16 through 4×4 pixels. By this motion prediction and compensation process, a predicted image is generated in each of the inter prediction modes.

The motion prediction/compensation unit 76 in step S63 generates motion vector information to be added to a compressed image with regard to the motion vector determined for each of the eight types of inter prediction modes having 16×16 through 4×4 pixels.

The generated motion vector information is also used during a cost function value calculation in the next step S64 and is output to the lossless coding unit 66 together with prediction mode information and reference frame information when a corresponding predicted image is eventually selected by the predicted image selection unit 77.

The motion prediction/compensation unit 76 in step S64 calculates the cost function value according to the above-described expression (69) or expression (70) with respect to each of the eight types of inter prediction modes having 16×16 through 4×4 pixels.

In step S65, the motion prediction/compensation unit 76 compares the cost function values calculated with respect to the inter prediction modes in step S64 and selects a prediction mode that gives the minimum value as the optimum inter prediction mode. The optimum inter mode determination unit 84 supplies the predicted image generated in the optimum inter prediction mode and the corresponding cost function value to the predicted image selection unit 77.

Then, in the above-described step S23 of FIG. 19, when the predicted image generated in the optimum inter prediction mode is selected by the predicted image selection unit 77, the motion prediction/compensation unit 76 supplies information indicating the optimum inter prediction mode, motion vector information, and reference image information and the like to the lossless coding unit 66. The information are coded in the lossless coding unit 66 and added to the header information of the compressed image (as described above in step S24 of FIG. 19).

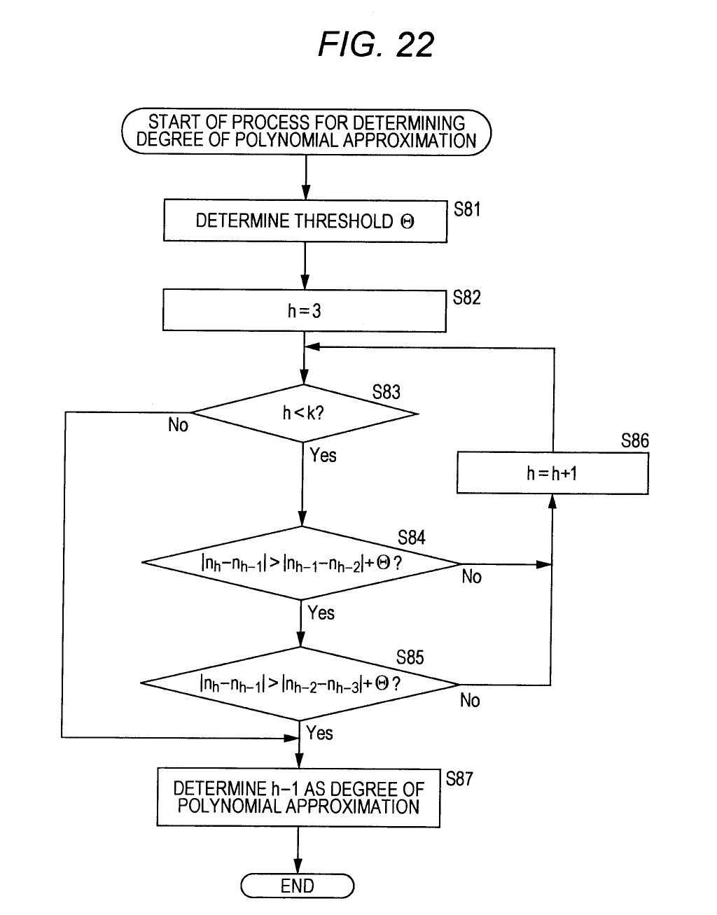

Next, a process of determining the degree of polynomial approximation used for intra prediction of FIG. 20 will be described with reference to a flowchart of FIG. 22. This process, which includes a process of determining the number of lines of the adjacent pixels that are used, as described above with reference to FIG. 16, is performed by the adjacent pixel selection unit 91 of FIG. 18 or the adjacent pixel selection unit 191 of FIG. 24 prior to selecting the adjacent pixels, for example.

As the value of the threshold Θ is input from an operation input unit or the like, which is not illustrated, by user operation, the adjacent pixel selection unit 91 determines the threshold Θ in step S81.

The adjacent pixel selection unit 91 in step S82 sets h=3 and determines in step S83 whether h is smaller than k. When it is determined that h is smaller than k, the process proceeds to step S84. k indicates the number of lines of the adjacent pixels stored in the line buffer 74.

The adjacent pixel selection unit 91 in step S84 determines whether a determination expression |nₕ−nₕ₋₁|>|nₕ₋₁−nₕ₋₂|+Θ is satisfied. When it is determined that the determination expression is satisfied in step S84, the process proceeds to step S85.

In step S85, it is determined whether a determination expression |nₕ₋₁−nₕ₋₂|>|nₕ₋₂−nₕ₋₃|+Θ is satisfied. When it is determined in step S84 that the determination expression is not satisfied, or when the determination expression in step S85 is not satisfied, the process proceeds to step S86.

In step S86, the adjacent pixel selection unit 91 sets h=h+1, returns to step S83, and repeats the subsequent process.

When it is determined that the determination expression is satisfied in step S85, namely, when the expression (68) is valid, the process proceeds to step S87. In step S87, the adjacent pixel selection unit 91 determines the degree of polynomial approximation to be h−1. In this case, h rows of the line buffer (adjacent pixel values) are used.

On the other hand, when it is determined in step S83 that h equals k, the process proceeds to step S87. In this case, the degree of polynomial approximation is determined to be k−1 in step S87, and k rows of the line buffer (adjacent pixel values) are used.

Thus, in the image coding apparatus 51, an intra predicted image is generated by performing an extrapolation process based on polynomial approximation using the adjacent pixels of a plurality of lines. In this way, intra prediction accuracy and coding efficiency can be improved. This is particularly effective in the case of large block sizes.

Further, the number of lines used is determined by determining whether an object boundary is included by comparing the pixel differences, so that prediction efficiency can be further improved.

The coded compressed image is transmitted via a predetermined transmission path and then decoded by an image decoding apparatus.

### [Example of Configuration of Image Decoding Apparatus]

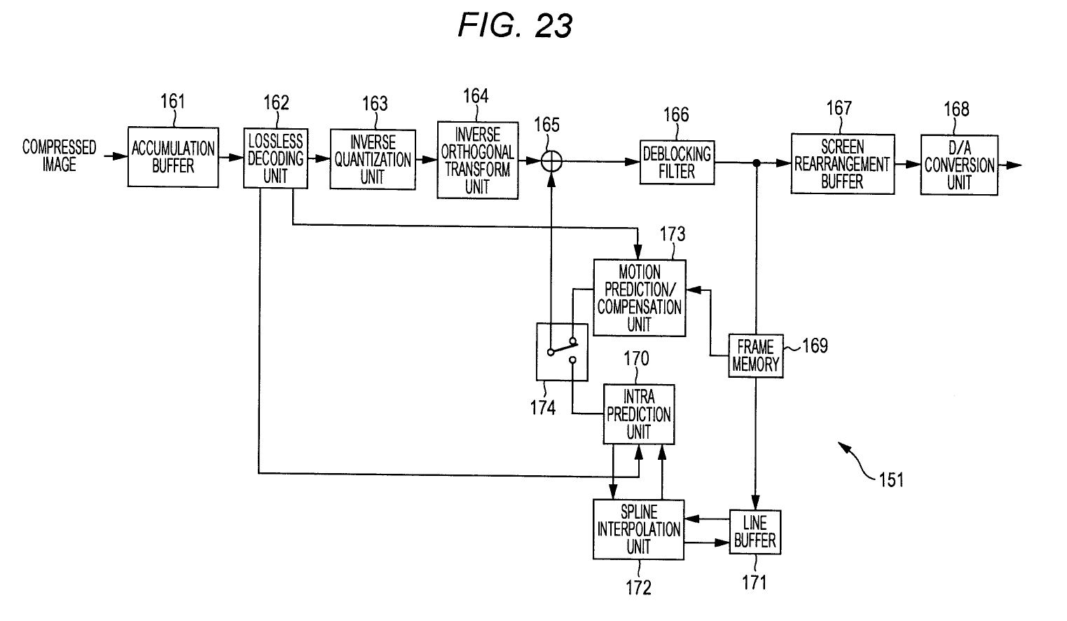

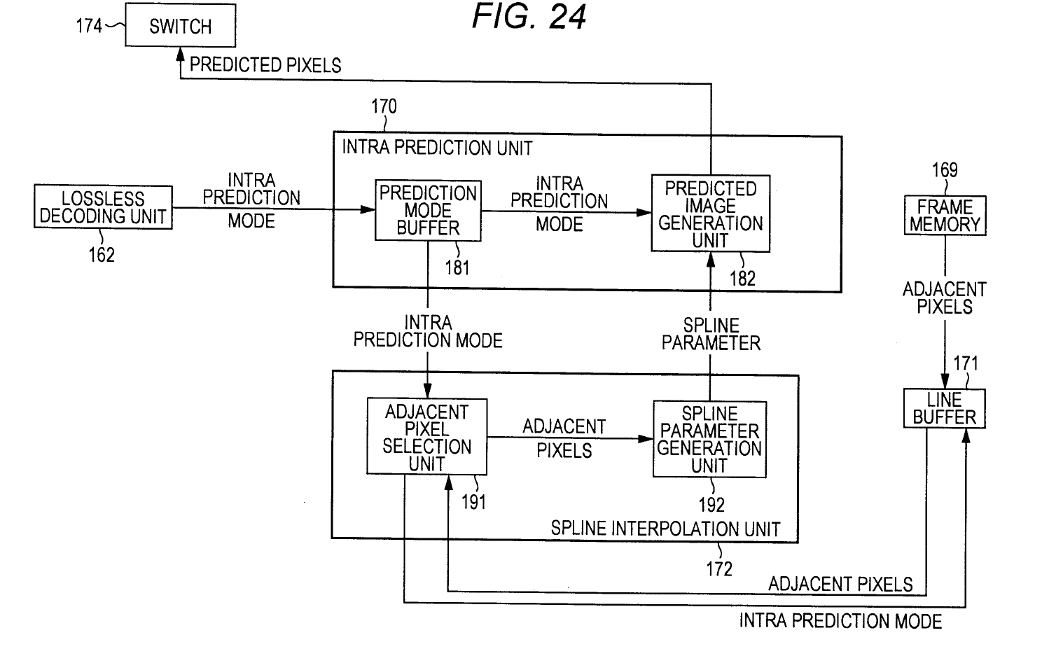

FIG. 23 illustrates a configuration of an embodiment of an image decoding apparatus as an image processing apparatus to which the present invention is applied.

An image decoding apparatus 151 includes an accumulation buffer 161, a lossless decoding unit 162, an inverse quantization unit 163, an inverse orthogonal transform unit 164, an arithmetic unit 165, a deblocking filter 166, a screen rearrangement buffer 167, a D/A conversion unit 168, a frame memory 169, an intra prediction unit 170, a line buffer 171, a spline interpolation unit 172, a motion prediction/compensation unit 173, and a switch 174.

The accumulation buffer 161 accumulates a compressed image transmitted thereto. The lossless decoding unit 162 decodes information supplied from the accumulation buffer 161 that has been coded by the lossless coding unit 66 of FIG. 2, in a scheme corresponding to the coding scheme of the lossless coding unit 66. The inverse quantization unit 163 inversely quantizes a decoded image from the lossless decoding unit 162 in a scheme corresponding to the quantization scheme of the quantization unit 65 of FIG. 2. The inverse orthogonal transform unit 164 subjects the output from the inverse quantization unit 163 to inverse orthogonal transform in a scheme corresponding to the orthogonal transform scheme of the orthogonal transform unit 64 of FIG. 2.

The inversely orthogonal transformed output is summed with a predicted image supplied from the switch 174 by the arithmetic unit 165 and decoded. The deblocking filter 166 supplies the decoded image to the frame memory 169 after removing block distortion and has the decoded image stored in the frame memory 169, while also outputting the decoded image to the screen rearrangement buffer 167.

The screen rearrangement buffer 167 performs image rearrangement. Namely, the screen rearrangement buffer 167 rearranges the order of frames rearranged by the screen rearrangement buffer 62 of FIG. 2 for coding back into the original order for display. The D/A conversion unit 168 subjects the image supplied from the screen rearrangement buffer 167 to D/A conversion and sends a resultant output to a display, which is not illustrated, for display.

An image to be inter processed and a referenced image from the frame memory 169 are output to the motion prediction/compensation unit 173. An image used for intra prediction from the frame memory 169 is output to the line buffer 171.

The intra prediction unit 170 is supplied, from the lossless decoding unit 162, with information obtained by decoding the header information indicating the intra prediction mode. The intra prediction unit 170 performs, together with the spline interpolation unit 172, an extrapolation process based on polynomial approximation using the adjacent pixels of a plurality of lines stored in the line buffer 171, whereby intra prediction pixel values of a current block is generated.

Specifically, the intra prediction unit 170 supplies the information of the intra prediction mode to the spline interpolation unit 172. The spline interpolation unit 172 supplies interpolation parameters of a polynomial approximating the adjacent pixels and current block pixels for intra prediction using the adjacent pixel values in accordance with the intra prediction mode. The intra prediction unit 170 generates an intra predicted image in the intra prediction mode selected on the coding end, according to the polynomial using the interpolation parameters from the spline interpolation unit 172.

The line buffer 171 accumulates the pixel values of the reference image from the frame memory 169. The line buffer 171 is supplied, from the spline interpolation unit 172, with the addresses of the adjacent pixels in accordance with the intra prediction mode. The line buffer 171 supplies the pixel values of the adjacent pixels corresponding to the addresses to the spline interpolation unit 172.

The spline interpolation unit 172 calculates, by using the adjacent pixel values supplied from the line buffer 171 in accordance with the addresses of the adjacent pixels corresponding to the intra prediction mode from the intra prediction unit 170, the interpolation parameters of the polynomial for intra prediction by polynomial approximation, and supplies the calculated interpolation parameters to the intra prediction unit 170.

The motion prediction/compensation unit 173 is supplied, from the lossless decoding unit 162, with the information obtained by decoding the header information (prediction mode information, motion vector information, and reference frame information). When the information indicating the inter prediction mode is supplied, the motion prediction/compensation unit 173 generates a predicted image by subjecting an image to a motion prediction and compensation process on the basis of the motion vector information and the reference frame information. The motion prediction/compensation unit 173 outputs the predicted image generated in the inter prediction mode to the switch 174.

The switch 174 selects the predicted image generated by the motion prediction/compensation unit 173 or the intra prediction unit 170 and supplies the predicted image to the arithmetic unit 165.

In the image coding apparatus 51 of FIG. 2, the intra prediction process is performed for all of the intra prediction modes for the prediction mode determination based on the cost function. On the other hand, in the image decoding apparatus 151, the intra prediction process is performed on the basis of only the information of the intra prediction mode which is received in coded form.

### [Example of Configuration of Intra Prediction Unit and Spline Interpolation Unit]

FIG. 24 is a block diagram of a detailed configuration of the intra prediction unit 170 and the spline interpolation unit 172.

In the example of FIG. 24, the intra prediction unit 170 includes a prediction mode buffer 181 and a predicted image generation unit 182. The spline interpolation unit 172 includes an adjacent pixel selection unit 191 and a spline parameter generation unit 192.

The prediction mode buffer 181 is supplied with the intra prediction mode information for the block from the lossless decoding unit 162. The intra prediction mode information is further supplied to the adjacent pixel selection unit 191.

The predicted image generation unit 182 generates a predicted image of the intra prediction mode from the prediction mode buffer 181 by using spline parameters from the spline parameter generation unit 192. Specifically, the predicted image generation unit 182 generates the predicted image by calculating P(0) through P(7) by using the N spline parameters determined by the expression (66) in the N−1 degree polynomial according to the expression (65). The generated predicted image is supplied to the switch 174.

The line buffer 171 receives and stores all of the adjacent pixels that may possibly be used for intra prediction from the frame memory 169. The adjacent pixel selection unit 191 selects which of the adjacent pixels should be used in accordance with the intra prediction mode from the prediction mode buffer 181, and supplies their addresses to the line buffer 171. The line buffer 171 supplies the values of the adjacent pixels to the adjacent pixel selection unit 191 by using the addresses. The adjacent pixel selection unit 191 then supplies the supplied values of the adjacent pixels to the spline parameter generation unit 192.

The spline parameter generation unit 192 calculates the N spline parameters of the N−1 degree polynomial for intra prediction by solving N simultaneous equations according to the expression (66) using the adjacent pixel values of N lines, and supplies the calculated N spline parameters to the predicted image generation unit 182.

### [Description of Decoding Process in Image Decoding Apparatus]

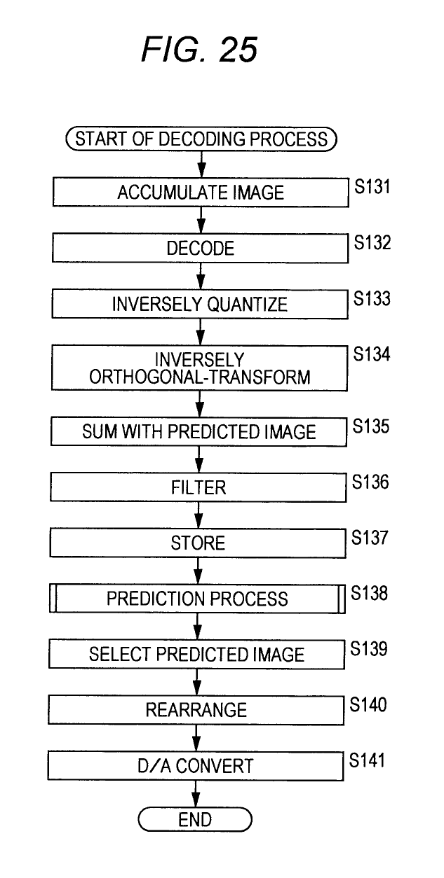

Next, a decoding process performed by the image decoding apparatus 151 will be described with reference to a flowchart of FIG. 25.

In step S131, the accumulation buffer 161 accumulates transmitted images.

In step S132, the lossless decoding unit 162 decodes a compressed image supplied from the accumulation buffer 161. Namely, the I-picture, the P-picture, and the B-picture coded by the lossless coding unit 66 of FIG. 2 are decoded.

At this time, motion vector information, reference frame information, and prediction mode information (information indicating the intra prediction mode or the inter prediction mode) and the like are also decoded.

Specifically, when the prediction mode information includes the intra prediction mode information, the prediction mode information is supplied to the intra prediction unit 170. When the prediction mode information includes the inter prediction mode information, the motion vector information and the reference frame information corresponding to the prediction mode information are supplied to the motion prediction/compensation unit 173.

In step S133, the inverse quantization unit 163 inversely quantizes the transform coefficient decoded by the lossless decoding unit 162 in accordance with characteristics corresponding to the characteristics of the quantization unit 65 of FIG. 2. In step S134, the inverse orthogonal transform unit 164 subjects the inversely quantized transform coefficient from the inverse quantization unit 163 to inverse orthogonal transform in accordance with characteristics corresponding to the characteristics of the orthogonal transform unit 64 of FIG. 2. Thus, the difference information corresponding to the input to the orthogonal transform unit 64 of FIG. 2 (output of the arithmetic unit 63) is decoded.

In step S135, the arithmetic unit 165 sums the predicted image selected by the process of step S139 and input via the switch 174, as will be described later, with the difference information, whereby the original image is decoded. In step S136, the deblocking filter 166 filters the image output from the arithmetic unit 165 and thereby removes block distortion. In step S137, the frame memory 169 stores the filtered image.

In step S138, the intra prediction unit 170 and the motion prediction/compensation unit 173 each perform an image prediction process in accordance with the prediction mode information supplied from the lossless decoding unit 162.

Specifically, when the intra prediction mode information is supplied from the lossless decoding unit 162, the intra prediction unit 170 and the spline interpolation unit 172 subject the pixels of the process current block to intra prediction in the intra prediction mode from the lossless decoding unit 162 by performing an extrapolation process based on polynomial approximation (i.e., spline interpolation process).

On the other hand, when the inter prediction mode information is supplied from the lossless decoding unit 162, the motion prediction/compensation unit 173 performs a compensation process on the reference image in the inter prediction mode from the lossless decoding unit 162 and by using the motion vector from the lossless decoding unit 162.

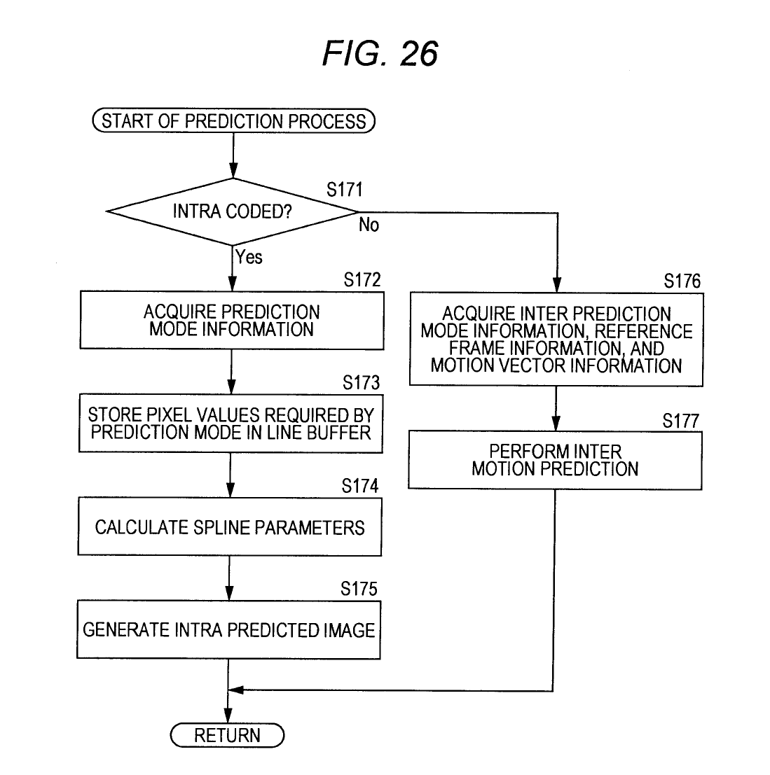

The details of the prediction process in step S138 will be described later with reference to FIG. 26. By this process, the predicted image generated by the intra prediction unit 170 or the motion prediction/compensation unit 173 is supplied to the switch 174.

In step S139, the switch 174 selects the predicted image. Specifically, the predicted image generated by the intra prediction unit 170 or the predicted image generated by the motion prediction/compensation unit 173 is supplied. Thus, the supplied predicted image is selected and supplied to the arithmetic unit 165 and then summed with the output from the inverse orthogonal transform unit 164 in step S135, as described above.

In step S140, the screen rearrangement buffer 167 performs rearrangement. Specifically, the screen rearrangement buffer 167 rearranges the order of frames rearranged by the screen rearrangement buffer 62 of the image coding apparatus 51 for coding to the original order for display.

In step S141, the D/A conversion unit 168 subjects the image from the screen rearrangement buffer 167 to D/A conversion. The converted image is output to a display, not illustrated, and displayed.

### [Description of Prediction Process]

Next, the prediction process in step S138 of FIG. 25 will be described with reference to a flowchart of FIG. 26.

The predicted image generation unit 182 and the adjacent pixel selection unit 191 in step S171 determine whether the current block is intra-coded. When the intra prediction mode information is supplied from the lossless decoding unit 162 to the predicted image generation unit 182 and the adjacent pixel selection unit 191 via the prediction mode buffer 181, the predicted image generation unit 182 and the adjacent pixel selection unit 191 determine in step S171 that the current block is intra-coded, and the process proceeds to step S172.

The predicted image generation unit 182 and the adjacent pixel selection unit 191 in step S172 acquire the prediction mode information.

The line buffer 171 stores a decoded image read from the frame memory 169 which is referenced for intra prediction.

The adjacent pixel selection unit 191 selects the adjacent pixel values necessary for the intra prediction mode in step S173 and supplies their addresses to the line buffer 171. The values of the adjacent pixels are supplied from the line buffer 171 to the adjacent pixel selection unit 191 on the basis of the addresses. The adjacent pixel selection unit 191 supplies the supplied values of the adjacent pixels to the spline parameter generation unit 192.

In step S174, the spline parameter generation unit 192 calculates the N spline parameters of the N−1 degree polynomial for the prediction mode from the prediction mode buffer 181 by solving the N simultaneous equations according to the expression (66), and supplies the calculated spline parameters to the predicted image generation unit 182.

In step S175, the predicted image generation unit 182 generates a predicted image for the prediction mode from the prediction mode buffer 181 by using the spline parameters from the spline parameter generation unit 192. Specifically, the predicted image is generated by calculating P(0) through P(7) by using the N spline parameters in the N−1 degree polynomial according to the expression (65). The generated predicted image is supplied to the cost function calculation unit 83 and supplied via the switch 174 to the arithmetic unit 165.

On the other hand, when it is determined in step S171 that the current block is not intra-coded, the process proceeds to step S176.

When the process target image is an image to be inter-processed, the inter prediction mode information, the reference frame information, and the motion vector information are supplied from the lossless decoding unit 162 to the motion prediction/compensation unit 173. In step S176, the motion prediction/compensation unit 173 acquires the inter prediction mode information, the reference frame information, and the motion vector information, for example, from the lossless decoding unit 162.

The motion prediction/compensation unit 173 in step S177 performs inter motion prediction. Specifically, when the process target image includes an image to be subjected to inter prediction process, necessary images are read from the frame memory 169 and supplied via the switch 170 to the motion prediction/compensation unit 173. In step S177, the motion prediction/compensation unit 173, on the basis of the motion vector acquired in step S176, performs a compensation process for the inter prediction mode and generates a predicted image. The generated predicted image is output to the switch 174.

Thus, in the image coding apparatus 51 and the image decoding apparatus 151, an intra predicted image is generated by performing an extrapolation process based on polynomial approximation using the adjacent pixels of a plurality of lines. Accordingly, intra prediction accuracy and coding efficiency can be improved. This is particularly effective in the case of large block sizes.

Because the same values of the spline parameters can be calculated by a similar process on the decoding side, there is no need to attach the values of the spline parameters to the header of the compressed image for transmission.

Currently, with a view to improving the coding efficiency beyond that of H.264/AVC, the JCTVC (Joint Collaboration Team Video Coding), which is a joint standardization collaboration of ITU-T and ISO/IEC, is in the process of standardizing a coding scheme referred to as “HEVC (High Efficiency Video Coding)”. As of September 2010, a draft “Test Model under Consideration” (JCTVC-B205) has been issued.

A Coding Unit defined in the HEVC coding scheme will be described.

The Coding Unit (CU), which may also be referred to as a “Coding Tree Block (CTB)”, provides a role similar to that of macroblock according to H.264/AVC. They differ from each other in that the latter is fixed to the size of 16×16 pixels, whereas the former is not fixed to any specific size and may include sizes designated in image compression information in each sequence.

Particularly, a CU having the maximum size is referred to as a LCU (Largest Coding Unit), while a CU having the minimum size is referred to as a SCU (Smallest Coding Unit). These sizes may be designated in a sequence parameter set included in the image compression information, where the sizes are limited to squares that can be expressed by the powers of two.

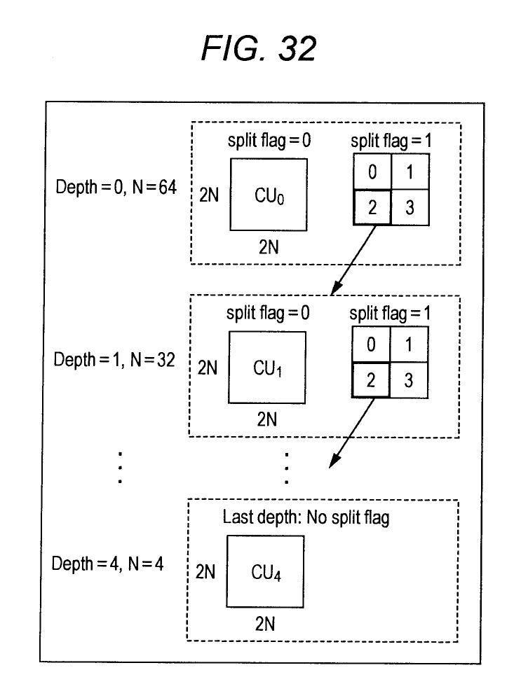

FIG. 32 illustrates an example of the Coding Units defined by the HEVC coding scheme. In the example of FIG. 32, the size of the LCU is 128, and the maximum hierarchy depth is five. A CU with the size 2N×2N is partitioned into CUs with the size N×N one layer below when the value of the split_flag is 1.

Further, the CU is partitioned into Prediction Units (PUs), which are the unit of intra or inter prediction, or into Transform Units (TUs), which are the unit of orthogonal transform.

The Coding Unit may be further partitioned into PUs (Prediction Units), which are the unit for intra or inter prediction, or TUs (Transform Units), which are the unit for orthogonal transform, for a prediction process or an orthogonal transform process. Currently, in the HEVC coding scheme, 16×16 and 32×32 orthogonal transforms may be used in addition to 4×4 and 8×8 orthogonal transforms.

In the present specification, the block and the macroblock include the concept of the Coding Unit (CU), the Prediction Unit (PU), and the Transform Unit (TU) as described above and are not limited to blocks having fixed sizes.

While the H.264/AVC scheme is used as a basis of coding scheme in the foregoing description, the present invention is not limited to this scheme. Other coding/decoding schemes for performing prediction by using adjacent pixels in a screen may be applied.

The present invention may be applied to image coding apparatuses and image decoding apparatuses for receiving image information (bit stream) compressed by orthogonal transform, such as discrete cosine transform, and motion compensation according to MPEG or H.26×, for example, via network media, such as satellite broadcast, cable television, the Internet, or portable telephone. The present invention may also be applied to image coding apparatuses and image decoding apparatuses used for performing processes on storage media, such as optical or magnetic disks and flash memory. Further, the present invention may be applied to a motion prediction and compensation apparatus included in such image coding apparatuses and image decoding apparatuses.

The above-described series of processes may be executed by hardware or software. When executing a series of processes by software, a program configuring the software may be installed in a computer, which may include a computer embedded in special hardware or a general-purpose personal computer capable of executing various functions by installing various programs therein.

### [Example of Configuration of Personal Computer]

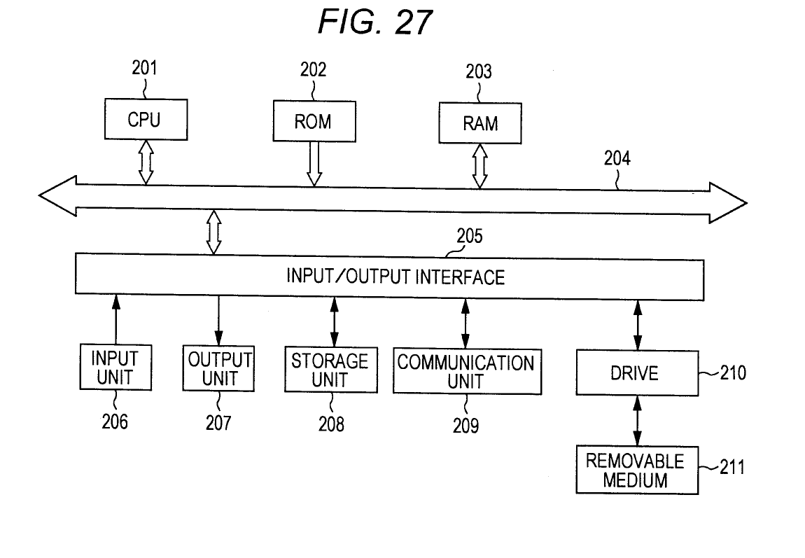

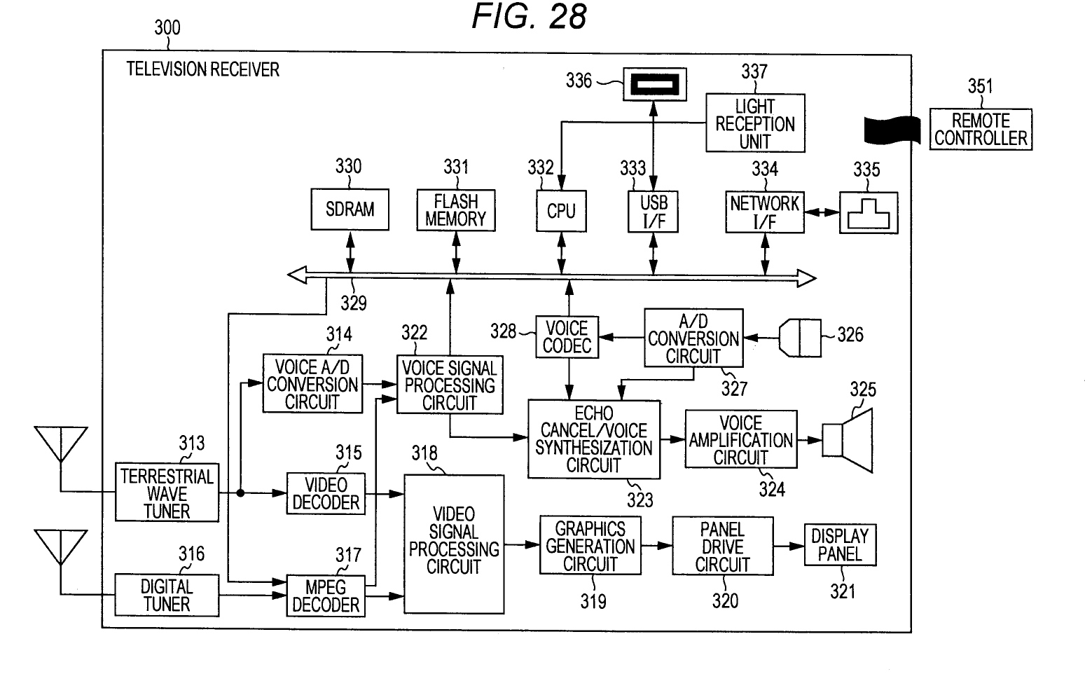

FIG. 27 is a block diagram of a hardware configuration of a computer that executes the above-described series of processes according to a program.

In the computer, a CPU (Central Processing Unit) 201, a ROM (Read Only Memory) 202, and a RAM (Random Access Memory) 203 are mutually connected via a bus 204.

To the bus 204, an input/output interface 205 is connected. To the input/output interface 205, an input unit 206, an output unit 207, a storage unit 208, a communication unit 209, and a drive 210 are connected.

The input unit 206 may include a keyboard, a mouse, and a microphone. The output unit 207 may include a display and a speaker. The storage unit 208 may include a hard disk and a nonvolatile memory. The communication unit 209 may include a network interface. The drive 210 drives a removable medium 211 which may include a magnetic disk, an optical disk, a magneto-optical disk, and a semiconductor memory.

For example, in the computer having the above configuration, the CPU 201 loads a program from the storage unit 208 into the RAM 203 via the input/output interface 205 and the bus 204 and executes the program in order to perform the above-described series of processes.

The program executed by the computer (CPU 201) may be recorded in the removable medium 211 provided as a package medium. The program may also be provided via wired or wireless transmission media, such as a local area network, the Internet, and digital broadcast.

In the computer, the program may be installed in the storage unit 208 via the input/output interface 205 by attaching the removable medium 211 to the drive 210. Alternatively, the program may be received by the communication unit 209 via wired or wireless transmission media and installed in the storage unit 208. Further alternatively, the program may be installed in the ROM 202 or the storage unit 208 in advance.

The program executed by the computer may include a program for executing processes in chronological order according to the sequences described in the present specification, or a program for executing processes in parallel or at desired timings, such as when called.

Embodiments of the present invention are not limited to the foregoing embodiments and may include various modifications without departing from the scope of the present invention.

For example, the image coding apparatus 51 or the image decoding apparatus 151 may be applied to various electronic devices as desired, of which an example will be described below.

### [Example of Configuration of Television Receiver]

FIG. 28 is a block diagram of a main configuration of a television receiver using an image decoding apparatus to which the present invention is applied.

A television receiver 300 illustrated in FIG. 28 includes a terrestrial wave tuner 313, a video decoder 315, a video signal processing circuit 318, a graphics generating circuit 319, a panel drive circuit 320, and a display panel 321.

The terrestrial wave tuner 313 receives a broadcast wave signal for terrestrial analog broadcast via an antenna and demodulates the signal, thereby acquiring a video signal which is supplied to the video decoder 315. The video decoder 315 performs a decoding process on the video signal supplied from the terrestrial wave tuner 313, and supplies a resultant digital component signal to the video signal processing circuit 318.

The video signal processing circuit 318 performs a predetermined process, such as noise removal, on the video data supplied from the video decoder 315, and supplies the resultant video data to the graphics generating circuit 319.

The graphics generating circuit 319 generates video data for a program to be displayed on the display panel 321, or image data obtained by a process based on an application supplied via a network, and supplies the generated video data or image data to the panel drive circuit 320. The graphics generating circuit 319 may also generate video data (graphics) for displaying a screen utilized by a user for selecting items, superpose the graphics on the video data for the program, and supply the resultant video data to the panel drive circuit 320 as needed.

The panel drive circuit 320 drives the display panel 321 on the basis of the data supplied from the graphics generating circuit 319 so as to cause a picture of the program or various screens mentioned above to be displayed on the display panel 321.

The display panel 321 may include a LCD (Liquid Crystal Display) that displays the picture of the program and the like according to the control by the panel drive circuit 320.

The television receiver 300 also includes a voice A/D (Analog/Digital) conversion circuit 314, a voice signal processing circuit 322, an echo cancel/voice synthesization circuit 323, a voice amplification circuit 324, and a speaker 325.

The terrestrial wave tuner 313 acquires not only a video signal but also a voice signal by demodulating the received broadcast wave signal. The terrestrial wave tuner 313 supplies the acquired voice signal to the voice A/D conversion circuit 314.

The voice A/D conversion circuit 314 performs an A/D conversion process on the voice signal supplied from the terrestrial wave tuner 313, and supplies a resultant digital voice signal to the voice signal processing circuit 322.

The voice signal processing circuit 322 performs a predetermined process, such as noise removal, on the voice data supplied from the voice A/D conversion circuit 314, and supplies obtained voice data to the echo cancel/voice synthesization circuit 323.

The echo cancel/voice synthesization circuit 323 supplies the voice data supplied from the voice signal processing circuit 322 to the voice amplification circuit 324.

The voice amplification circuit 324 performs a D/A conversion process and an amplification process on the voice data supplied from the echo cancel/voice synthesization circuit 323, and causes the speaker 325 to output voice sound after adjusting to a predetermined volume.

The television receiver 300 further includes a digital tuner 316 and a MPEG decoder 317.

The digital tuner 316 receives a broadcast wave signal of digital broadcast (terrestrial digital broadcast, BS (Broadcasting Satellite)/CS (Communications Satellite) digital broadcast) via an antenna, demodulates the broadcast wave signal to acquire a MPEG-TS (Moving Picture Experts Group-Transport Stream), and supplies the MPEG-TS to the MPEG decoder 317.

The MPEG decoder 317 descrambles the MPEG-TS supplied from the digital tuner 316, and extracts a stream including the data of the program as a reproduction target (target for viewing). The MPEG decoder 317 decodes voice packets constituting the extracted stream, and supplies resultant voice data to the voice signal processing circuit 322, while also decoding video packets constituting the stream and supplying resultant video data to the video signal processing circuit 318. Further, the MPEG decoder 317 supplies EPG (Electronic Program Guide) data extracted from the MPEG-TS to the CPU 332 via a path which is not illustrated.

The television receiver 300 employs the image decoding apparatus 151 as the MPEG decoder 317 that decodes the video packets as described above. Thus, the MPEG decoder 317 can improve coding efficiency during intra prediction as in the case of the image decoding apparatus 151.

The video data supplied from the MPEG decoder 317 is subjected to a predetermined process in the video signal processing circuit 318, as in the case of the video data supplied from the video decoder 315. The video data that has been subjected to the predetermined process may be superposed with generated video data in the graphics generating circuit 319 as needed, and then supplied via the panel drive circuit 320 to the display panel 321 for displaying a corresponding image.

The voice data supplied from the MPEG decoder 317 is subjected to a predetermined process in the voice signal processing circuit 322, as in the case of the voice data supplied from the voice A/D conversion circuit 314. The voice data that has been subjected to the predetermined process is supplied via the echo cancel/voice synthesization circuit 323 to the voice amplification circuit 324, where a D/A conversion process and an amplification process may be performed. As a result, voice sound adjusted to a predetermined volume is output from the speaker 325.

The television receiver 300 also includes a microphone 326 and an A/D conversion circuit 327.

The A/D conversion circuit 327 receives a signal of the user's voice collected by the microphone 326 installed in the television receiver 300 for voice conversation. The A/D conversion circuit 327 subjects the received voice signal to an A/D conversion process and supplies resultant digital voice data to the echo cancel/voice synthesization circuit 323.

The echo cancel/voice synthesization circuit 323, when the voice data of the user (user A) of the television receiver 300 is supplied from the A/D conversion circuit 327, performs echo cancelling on the voice data of the user A. After echo cancelling, the echo cancel/voice synthesization circuit 323 causes the voice data, which may be synthesized with other voice data, to be output from the speaker 325 via the voice amplification circuit 324.

The television receiver 300 further includes a voice codec 328, an internal bus 329, a SDRAM (Synchronous Dynamic Random Access Memory) 330, a flash memory 331, a CPU 332, an USB (Universal Serial Bus) I/F 333, and a network I/F 334.

The A/D conversion circuit 327 receives a signal of the user's voice collected by the microphone 326 installed in the television receiver 300 for voice conversation. The A/D conversion circuit 327 subjects the received voice signal to an A/D conversion process, and supplies resultant digital voice data to the voice codec 328.

The voice codec 328 converts the voice data supplied from the A/D conversion circuit 327 into data in a predetermined format for network transmission, and supplies the data to the network I/F 334 via the internal bus 329.

The network I/F 334 is connected to a network via a cable attached to a network terminal 335. The network I/F 334 may transmit the voice data supplied from the voice codec 328 to another apparatus connected to the network. The network I/F 334 may also receive voice data transmitted from the other apparatus connected to the network via the network terminal 335, and supply the received voice data to the voice codec 328 via the internal bus 329.

The voice codec 328 converts the voice data supplied from the network I/F 334 into data in a predetermined format, and supplies the data to the echo cancel/voice synthesization circuit 323.

The echo cancel/voice synthesization circuit 323 performs echo cancelling on the voice data supplied from the voice codec 328, and causes the voice data, which may be synthesized with other voice data, to be output from the speaker 325 via the voice amplification circuit 324.

The SDRAM 330 stores various data used by the CPU 332 in performing processes.

The flash memory 331 stores a program executed by the CPU 332. The program stored in the flash memory 331 may be read by the CPU 332 at a predetermined timing, such as at the time of starting the television receiver 300. The flash memory 331 may also store EPG data acquired via digital broadcast, or data acquired from a predetermined server via a network.

For example, the flash memory 331 stores the MPEG-TS including content data acquired from the predetermined server via the network under the control of the CPU 332. The flash memory 331 may supply the MPEG-TS to the MPEG decoder 317 via the internal bus 329 under the control of the CPU 332.

The MPEG decoder 317 processes the MPEG-TS in a manner similar to the processing of the MPEG-TS supplied from the digital tuner 316. Thus, the television receiver 300 can receive the content data including video and voice via a network, decode the data using the MPEG decoder 317, and cause a corresponding video or voice sound to be displayed or output.

The television receiver 300 also includes a light reception unit 337 for receiving an infrared signal from the remote controller 351.

The light reception unit 337 receives infrared light from the remote controller 351, demodulates it, and then outputs an obtained control code representing the content of user operation to the CPU 332.

The CPU 332 executes the program stored in the flash memory 331 and controls the television receiver 300 as a whole in accordance with the control code and the like supplied from the light reception unit 337. The CPU 332 and the various units of the television receiver 300 are connected via a path which is not illustrated.

The USB I/F 333 transmits or receives data to or from an external device connected to the television receiver 300 via a USB cable attached to an USB terminal 336. The network I/F 334 may also connect to a network via a cable attached to the network terminal 335 and transmit or receive data other than voice data to or from various apparatuses connected to a network.

The television receiver 300 can improve coding efficiency by using the image decoding apparatus 151 as the MPEG decoder 317. As a result, the television receiver 300 can obtain a decoded image of higher resolution from the broadcast wave signal received via the antenna or the content data acquired via a network, and display the decoded image.

### [Example of Configuration of Portable Telephone]

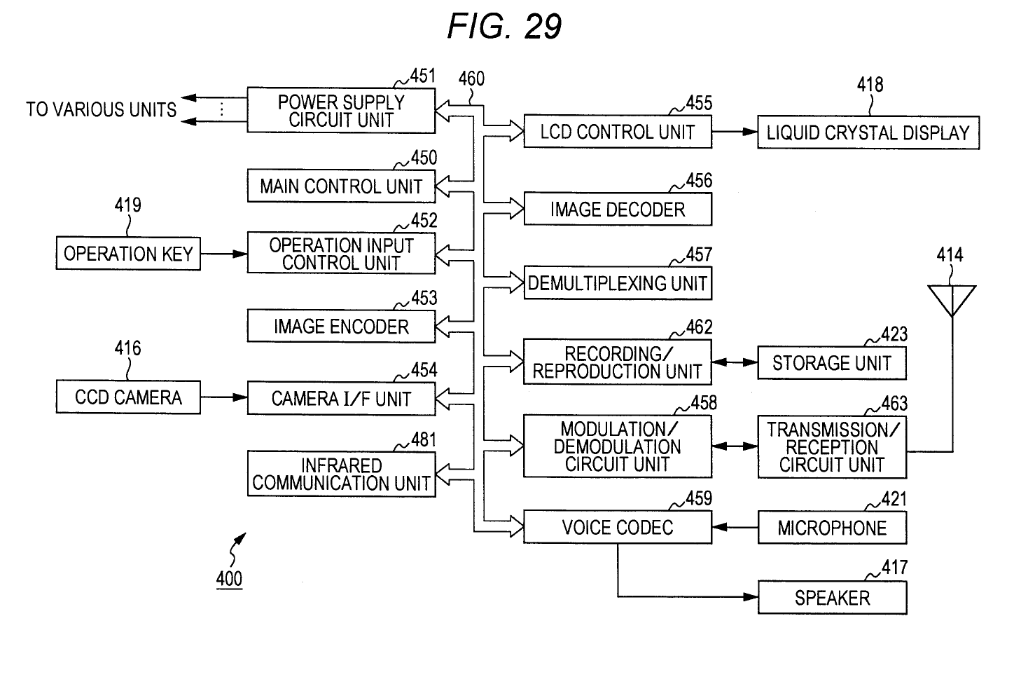

FIG. 29 is a block diagram of a main configuration of a portable telephone using an image coding apparatus and an image decoding apparatus to which the present invention is applied.

A portable telephone 400 illustrated in FIG. 29 includes a main control unit 450 for generally controlling various units, a power supply circuit unit 451, an operation input control unit 452, an image encoder 453, a camera I/F unit 454, a LCD control unit 455, an image decoder 456, a demultiplexing unit 457, a recording/reproduction unit 462, a modulation/demodulation circuit unit 458, and a voice codec 459. These units are connected to each other via a bus 460.

The portable telephone 400 also includes an operation key 419, a CCD (Charge Coupled Device) camera 416, a liquid crystal display 418, a storage unit 423, a transmission/reception circuit unit 463, an antenna 414, a microphone (MIC) 421, and a speaker 417.

The power supply circuit unit 451 supplies electric power from a battery pack to the various units when a call-terminating and power supply key is placed in an on-state by user operation, so that the portable telephone 400 can be started into an operable state.

The portable telephone 400, on the basis of control by the main control unit 450 which may include a CPU, a ROM, and a RAM, performs various operations, such as transmission and reception of a voice signal, transmission and reception of electronic mail or image data, taking an image, or recording data, in various modes, such as a voice call mode or a data communication mode.

For example, in the voice call mode, the portable telephone 400 converts a voice signal collected by the microphone (MIC) 421 into digital voice data by using the voice codec 459, subjects the digital voice data to a spectrum spreading process by using the modulation/demodulation circuit unit 458, and performs a digital-analog conversion process and a frequency conversion process by using the transmission/reception circuit unit 463. The portable telephone 400 then transmits a transmission signal obtained by the conversion processes to a base station, not illustrated, via the antenna 414. The transmission signal (voice signal) transmitted to the base station is supplied to a portable telephone of an intended party via a public telephone line network.

Further, in the voice call mode for example, the portable telephone 400 amplifies a reception signal received via the antenna 414 by using the transmission/reception circuit unit 463, performs a frequency conversion process and an analog-digital conversion process, performs a spectrum de-spreading process in the modulation/demodulation circuit unit 458, and then converts a resultant signal into an analog voice signal by using the voice codec 459. The portable telephone 400 outputs the resultant analog voice signal via the speaker 417.

When electronic mail is transmitted in the data communication mode, for example, the portable telephone 400 receives text data of electronic mail input by an operation of the operation key 419 in the operation input control unit 452. The portable telephone 400 then processes the text data in the main control unit 450, and causes the liquid crystal display 418 to display a corresponding image via the LCD control unit 455.

Further, the portable telephone 400 generates electronic mail data in the main control unit 450 on the basis of the text data or a user instruction received by the operation input control unit 452. The portable telephone 400 subjects the electronic mail data to a spectrum spreading process in the modulation/demodulation circuit unit 458 and to a digital-analog conversion process and a frequency conversion process in the transmission/reception circuit unit 463. The portable telephone 400 then transmits a transmission signal obtained by the conversion processes to the base station, not illustrated, via the antenna 414. The transmission signal (electronic mail) transmitted to the base station is supplied to a predetermined destination via a network and a mail server and the like.

When receiving electronic mail in the data communication mode, for example, the portable telephone 400 receives a signal transmitted from the base station by using the transmission/reception circuit unit 463 via the antenna 414, amplifies the signal, and subjects the signal to a frequency conversion process and an analog-digital conversion process. The portable telephone 400 then subjects the reception signal to a spectrum de-spreading process in the modulation/demodulation circuit unit 458 so as to recover original electronic mail data. The portable telephone 400 causes the recovered electronic mail data to be displayed by the liquid crystal display 418 via the LCD control unit 455.

The portable telephone 400 may also record (store) the received electronic mail data in the storage unit 423 via the recording/reproduction unit 462.

The storage unit 423 includes a rewritable storage medium. The storage unit 423 may include a semiconductor memory such as a RAM and a built-in flash memory, a hard disk, and a removable medium such as a magnetic disk, a magneto-optical disk, an optical disk, a USB memory, or a memory card. Other forms of storage unit may also be used.

When transmitting image data in the data communication mode, for example, the portable telephone 400 generates image data by using the CCD camera 416 for imaging. The CCD camera 416 includes an optical device such as lenses and an aperture, and a CCD as a photoelectric conversion element. The CCD camera 416 images a subject, converts the intensity of received light into an electric signal, and generates image data of an image of the subject. The image data is supplied via the camera OF unit 454 to the image encoder 453, in which the image data is compressed and coded into coded image data in a predetermined coding scheme, such as MPEG2 or MPEG4.

The portable telephone 400 uses the image coding apparatus 51 as the image encoder 453 for performing the above process. Thus, the image encoder 453 can improve the coding efficiency in intra prediction as in the case of the image coding apparatus 51.

At the same time, the portable telephone 400 subjects voice sound collected by the microphone (MIC) 421 during imaging by the CCD camera 416 to analog-digital conversion in the voice codec 459 and further codes the voice sound.

The portable telephone 400 multiplexes the coded image data supplied from the image encoder 453 and the digital voice data supplied from the voice codec 459 in the demultiplexing unit 457 in a predetermined scheme. The portable telephone 400 subjects resultant multiplexed data to a spectrum spreading process in the modulation/demodulation circuit unit 458 and to a digital-analog conversion process and a frequency conversion process in the transmission/reception circuit unit 463. The portable telephone 400 transmits a transmission signal obtained by the conversion processes to the base station, not illustrated, via the antenna 414. The transmission signal (image data) transmitted to the base station is supplied to an intended party via a network, for example.

When image data is not transmitted, the portable telephone 400 may cause the image data generated by the CCD camera 416 to be displayed on the liquid crystal display 418 via the LCD control unit 455 and not via the image encoder 453.

In the data communication mode, when receiving data of a moving image file linked to a simple home page, for example, the portable telephone 400 receives a signal transmitted from the base station in the transmission/reception circuit unit 463 via the antenna 414, amplifies the signal, and subjects the signal to a frequency conversion process and an analog-digital conversion process. The portable telephone 400 then subjects the reception signal to a spectrum de-spreading process in the modulation/demodulation circuit unit 458 so as to recover original multiplexed data. The portable telephone 400 separates the multiplexed data into coded image data and voice data in the demultiplexing unit 457.

The portable telephone 400 decodes the coded image data in the image decoder 456 in a decoding scheme corresponding to the predetermined coding scheme such as MPEG2 or MPEG4 and thereby generates moving image data for reproduction, and causes the data to be displayed on the liquid crystal display 418 via the LCD control unit 455. In this way, the moving image data included in the moving image file linked to the simple home page, for example, can be displayed on the liquid crystal display 418.

The portable telephone 400 uses the image decoding apparatus 151 as the image decoder 456 for performing the above process. Thus, the image decoder 456 can improve the coding efficiency in intra prediction as in the case of the image decoding apparatus 151.

At the same time, the portable telephone 400 converts the digital voice data into an analog voice signal in the voice codec 459 and causes the analog voice signal to be output from the speaker 417. As a result, the voice data included in the moving image file linked to the simple home page, for example, can be reproduced.

As in the case of electronic mail, the portable telephone 400 may also record (store) the received data linked to the simple home page and the like in the storage unit 423 via the recording/reproduction unit 462.

The portable telephone 400 may also analyze a two-dimensional code imaged and obtained by the CCD camera 416 in the main control unit 450, and thereby acquire information recorded in the two-dimensional code.

Further, the portable telephone 400 may communicate with an external device using infrared via the infrared communication unit 481.

The portable telephone 400 can improve coding efficiency by using the image coding apparatus 51 as the image encoder 453. Thus, the portable telephone 400 can provide coded data (image data) having high coding efficiency to other apparatuses.

The portable telephone 400 can improve coding efficiency by using the image decoding apparatus 151 as the image decoder 456. As a result, the portable telephone 400 can obtain a decoded image having higher resolution from the moving image file linked to the simple home page, for example, and display the image.

While the portable telephone 400 has been described as using the CCD camera 416, the portable telephone 400 may use an image sensor (CMOS image sensor) including a CMOS (Complementary Metal Oxide Semiconductor), instead of the CCD camera 416. In this case, too, the portable telephone 400 can image a subject and generate image data of an image of the subject, as in the case of using the CCD camera 416.

Further, while the portable telephone 400 has been described, the image coding apparatus 51 or the image decoding apparatus 151 may be similarly applied to any apparatus having an imaging function or a communication function similar to those of the portable telephone 400, such as a PDA (Personal Digital Assistant), a smart phone, a UMPC (Ultra Mobile Personal Computer), a netbook, and a notebook computer.

### [Example of Configuration of Hard Disk Recorder]

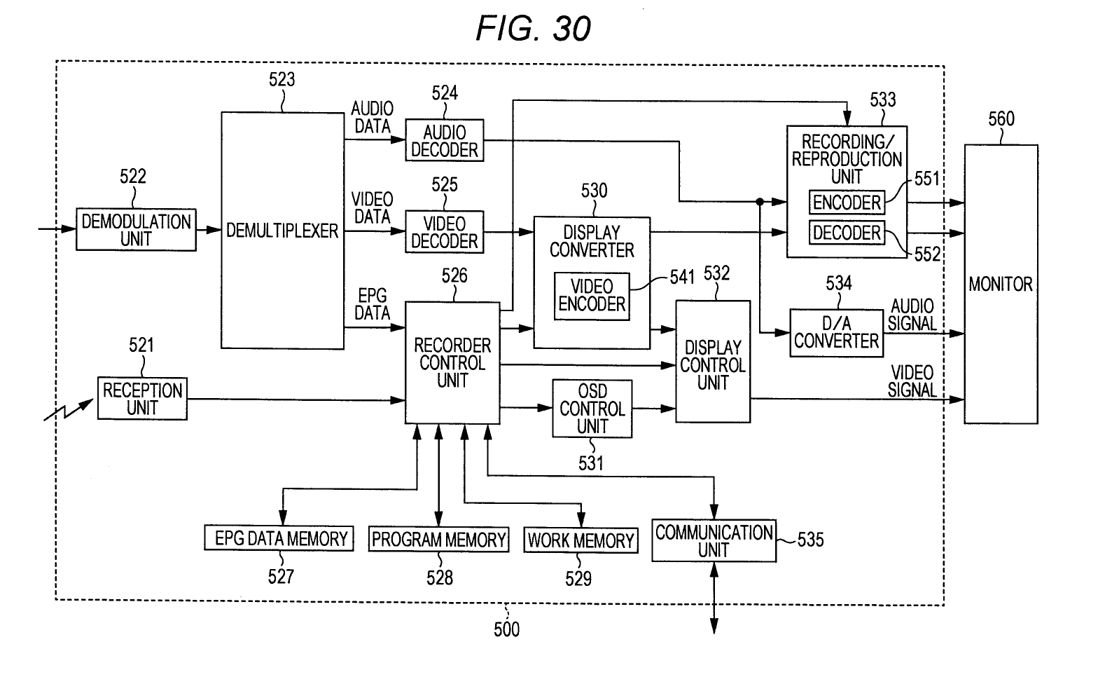

FIG. 30 is a block diagram of a main configuration of a hard disk recorder using the image coding apparatus and the image decoding apparatus to which the present invention is applied.

A hard disk recorder (HDD recorder) 500 illustrated in FIG. 30 is an apparatus that stores audio data and video data of a broadcast program included in a broadcast wave signal (television signal) transmitted from a satellite or terrestrial antenna and received by a tuner in a built-in hard disk, and provides the stored data to a user at a timing of user instruction.

The hard disk recorder 500 may extract the audio data and the video data from the broadcast wave signal, decode the data as needed, and store them in the built-in hard disk. The hard disk recorder 500 may also acquire audio data or video data from another apparatus via a network, decode the data as needed, and store the data in the built-in hard disk.

Further, the hard disk recorder 500 may decode the audio data or the video data recorded in the built-in hard disk and then supply the decoded data to a monitor 560, so that a corresponding image can be displayed on a screen of the monitor 560. The hard disk recorder 500 may also cause corresponding voice sound to be output via a speaker of the monitor 560.

The hard disk recorder 500 may decode the audio data and the video data extracted from the broadcast wave signal acquired via the tuner, or the audio data and the video data acquired from the other apparatus via the network, and supply the decoded data to the monitor 560, so that a corresponding image can be displayed on a screen of the monitor 560. The hard disk recorder 500 may also cause voice sound to be output via the speaker of the monitor 560.

It goes without saying that other operations are also possible.

As illustrated in FIG. 30, the hard disk recorder 500 includes a reception unit 521, a demodulation unit 522, a demultiplexer 523, an audio decoder 524, a video decoder 525, and a recorder control unit 526. The hard disk recorder 500 further includes an EPG data memory 527, a program memory 528, a work memory 529, a display converter 530, an OSD (On Screen Display) control unit 531, a display control unit 532, a recording/reproduction unit 533, a D/A converter 534, and a communication unit 535.

The display converter 530 includes a video encoder 541. The recording/reproduction unit 533 includes an encoder 551 and a decoder 552.

The reception unit 521 receives an infrared signal from a remote controller (not illustrated), converts the infrared signal into an electric signal, and outputs the electric signal to the recorder control unit 526. The recorder control unit 526 may include a microprocessor and perform various processes in accordance with a program stored in the program memory 528. At this time, the recorder control unit 526 may use the work memory 529 as needed.

The communication unit 535 is connected to a network and performs a communication process with other apparatuses via the network. For example, the communication unit 535 communicates with a tuner (not illustrated) and outputs a station-selection control signal mainly to the tuner under the control of the recorder control unit 526.

The demodulation unit 522 demodulates a signal supplied from the tuner and outputs a demodulated signal to the demultiplexer 523. The demultiplexer 523 separates the data supplied from the demodulation unit 522 into audio data, video data, and EPG data, and outputs these data to the audio decoder 524, the video decoder 525, and the recorder control unit 526, respectively.

The audio decoder 524 decodes the input audio data in MPEG scheme, for example, and outputs decoded data to the recording/reproduction unit 533. The video decoder 525 decodes the input video data in MPEG scheme, for example, and outputs decoded data to the display converter 530. The recorder control unit 526 supplies the input EPG data to the EPG data memory 527 and has the data stored therein.

The display converter 530 encodes the video data supplied from the video decoder 525 or the recorder control unit 526 into video data in a NTSC (National Television Standards Committee) scheme, for example, by using the video encoder 541, and outputs encoded data to the recording/reproduction unit 533, for example. The display converter 530 converts the screen size of the video data supplied from the video decoder 525 or the recorder control unit 526 into a size corresponding to the size of the monitor 560. The display converter 530 further converts the video data with the converted screen size into video data in NTSC scheme, i.e., into an analog signal, by using the video encoder 541, and outputs the analog signal to the display control unit 532.

The display control unit 532, under the control of the recorder control unit 526, superpose the OSD signal output from the OSD (On Screen Display) control unit 531 on the video signal input from the display converter 530, and supplies the superposed video signal to the monitor 560 for display.

The monitor 560 is also supplied with the audio data from the audio decoder 524 that has been converted into an analog signal by the D/A converter 534. The monitor 560 outputs the audio signal via a built-in speaker.

The recording/reproduction unit 533 includes a hard disk as a storage medium for storing video data and audio data, for example.

The recording/reproduction unit 533 encodes the audio data supplied from the audio decoder 524, for example, in MPEG scheme by using the encoder 551. The recording/reproduction unit 533 also encodes the video data supplied from the video encoder 541 of the display converter 530 in MPEG scheme by using the encoder 551. The recording/reproduction unit 533 composes the coded data of audio data and the coded data of video data by using a multiplexer. The recording/reproduction unit 533 channel-codes and amplifies the composed data, and writes resultant data into the hard disk via a recording head.

The recording/reproduction unit 533 reproduces the data recorded in the hard disk via a reproduction head, amplifies the data, and separates the data into audio data and video data by using a demultiplexer. The recording/reproduction unit 533 decodes the audio data and the video data in MPEG scheme by using the decoder 552. The recording/reproduction unit 533 subjects the decoded audio data to D/A conversion and outputs a converted signal to the speaker of the monitor 560. Further, the recording/reproduction unit 533 subjects the decoded video data to D/A conversion and outputs a converted signal to the monitor 560 for display.

The recorder control unit 526, on the basis of a user instruction indicated by an infrared signal received via the reception unit 521 from a remote controller, reads the latest EPG data from the EPG data memory 527, and supplies the data to the OSD control unit 531. The OSD control unit 531 generates image data corresponding to the input EPG data, and outputs the data to the display control unit 532. The display control unit 532 outputs the video data input from the OSD control unit 531 to the monitor 560 for display. Thus, an EPG (electronic program guide) is displayed on the monitor 560.

The hard disk recorder 500 may acquire various data from another apparatus via a network, such as the Internet, the data including video data, audio data, and EPG data.

For example, the communication unit 535 acquires coded data such as video data, audio data, or EPG data from the other apparatus via the network, under the control of the recorder control unit 526, and supplies the data to the recorder control unit 526. The recorder control unit 526 may supply the acquired coded data, such as video data and audio data, to the recording/reproduction unit 533 and have the data stored in the hard disk. The recorder control unit 526 and the recording/reproduction unit 533 may perform a re-encoding process and the like as needed.

The recorder control unit 526 decodes the acquired coded data such as the video data and the audio data, and supplies resultant video data to the display converter 530. The display converter 530, as in the case of the video data supplied from the video decoder 525, processes the video data supplied from the recorder control unit 526, and supplies the processed video data to the monitor 560 via the display control unit 532 so that a corresponding image can be displayed on the monitor 560.

The recorder control unit 526 may supply the decoded audio data to the monitor 560 via the D/A converter 534 in accordance with the image display so that corresponding voice sound can be output via the speaker.

Further, the recorder control unit 526 decodes the coded data of the acquired EPG data, and supplies the decoded EPG data to the EPG data memory 527.

The hard disk recorder 500 employs the image decoding apparatus 151 as the decoders in the video decoder 525, the decoder 552, and the recorder control unit 526. Thus, the decoders in the video decoder 525, the decoder 552, and the recorder control unit 526 can improve the coding efficiency in intra prediction, as in the case of the image decoding apparatus 151.

Accordingly, the hard disk recorder 500 can generate a highly accurate predicted image. As a result, the hard disk recorder 500 can obtain a decoded image having higher resolution from the coded data of the video data received via the tuner, the coded data of the video data read from the hard disk in the recording/reproduction unit 533, or the coded data of the video data acquired via a network, and have the image displayed on the monitor 560.

The hard disk recorder 500 uses the image coding apparatus 51 as the encoder 551. Thus, the encoder 551 can improve the coding efficiency in intra prediction, as in the case of the image coding apparatus 51.

Therefore, the hard disk recorder 500 can improve the coding efficiency of coded data recorded in the hard disk, for example. As a result, the hard disk recorder 500 can utilize the memory area of the hard disk more efficiently.

While the foregoing description has been made with reference to the hard disk recorder 500 that records video data or audio data in a hard disk, any type of recording medium may be used. For example, the image coding apparatus 51 and the image decoding apparatus 151 can be applied to a recorder that uses a recording medium other than a hard disk, such as a flash memory, an optical disk, or a video tape, in the same way as in the case of the hard disk recorder 500.

### [Example of Configuration of Camera]

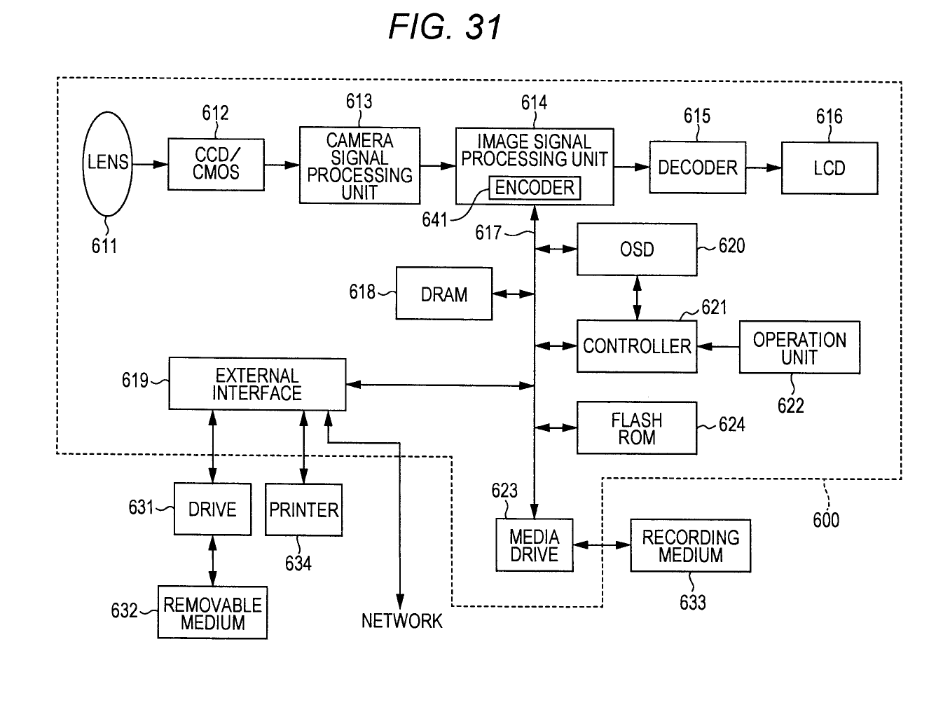

FIG. 31 is a block diagram of a main configuration of a camera that uses the image decoding apparatus and the image coding apparatus to which the present invention is applied.

A camera 600 illustrated in FIG. 31 images a subject and displays an image of the subject on a LCD 616 or records the image in a recording medium 633 as image data.

A lens block 611 causes light (i.e., a picture of the subject) to be incident on a CCD/CMOS 612. The CCD/CMOS 612, which may include a CCD or CMOS image sensor, converts the intensity of the received light into an electric signal and supplies the electric signal to a camera signal processing unit 613.

The camera signal processing unit 613 supplies the electric signal supplied from the CCD/CMOS 612 into chrominance signals for Y, Cr, and Cb, and supplies the chrominance signals to the image signal processing unit 614. The image signal processing unit 614, under the control of a controller 621, may subject the image signal supplied from the camera signal processing unit 613 to a predetermined image process or code the image signal in MPEG scheme, for example, in an encoder 641. The image signal processing unit 614 supplies coded data generated by coding the image signal to the decoder 615. The image signal processing unit 614 also acquires display data generated in an onscreen display (OSD) 620 and supplies the display data to the decoder 615.

In the above process, the camera signal processing unit 613 may utilize a DRAM (Dynamic Random Access Memory) 618 connected via a bus 617 and have image data or coded data obtained by coding the image data stored in the DRAM 618 as needed.

The decoder 615 decodes the coded data supplied from the image signal processing unit 614, and supplies resultant image data (decoded image data) to an LCD 616. The decoder 615 also supplies the display data supplied from the image signal processing unit 614 to the LCD 616. The LCD 616 composes an image of the decoded image data and an image of the display data supplied from the decoder 615 in an appropriate manner, and displays a composed image.

The onscreen display 620, under the control of the controller 621, outputs the display data, which may include a menu screen having signs, characters, or figures, and icons to the image signal processing unit 614 via the bus 617.

The controller 621 performs various processes on the basis of a signal indicating the content of an instruction entered by the user via the operation unit 622, and controls an image signal processing unit 614, a DRAM 618, an external interface 619, an onscreen display 620, and a media drive 623, for example, via the bus 617. In the flash ROM 624, programs and data used by the controller 621 in performing various processes may be stored.

For example, the controller 621 can code image data stored in the DRAM 618 or decode coded data stored in the DRAM 618 in place of the image signal processing unit 614 or the decoder 615. In this case, the controller 621 may perform the coding or decoding process in the same scheme as the coding or decoding scheme of the image signal processing unit 614 or the decoder 615. Alternatively, the controller 621 may perform the coding or decoding process in a scheme with which the image signal processing unit 614 or the decoder 615 is not compatible.

When an instruction for starting the printing of an image is entered via the operation unit 622, for example, the controller 621 reads image data from the DRAM 618 and supplies the image data via the bus 617 to a printer 634 connected to the external interface 619 for printing.

When an instruction for recording an image is entered via the operation unit 622, for example, the controller 621 reads coded data from the DRAM 618 and supplies the coded data via the bus 617 to the recording medium 633 attached to the media drive 623 for storage.

The recording medium 633 may include a removable medium that can be read and written, such as a magnetic disk, a magneto-optical disk, an optical disk, or a semiconductor memory. The recording medium 633 may include any type of removable medium, such as a tape device, a disk, or a memory card. The recording medium 633 may also include a contactless IC card.

The media drive 623 and the recording medium 633 may be integrated into a non-transportable storage medium, such as a built-in hard disk drive or a SSD (Solid State Drive).

The external interface 619 may include a USB input/output terminal and is connected to the printer 634 when printing an image. To the external interface 619, a drive 631 may be connected as needed. A removable medium 632, such as a magnetic disk, an optical disk, or a magneto-optical disk, may be attached to the drive 631 as needed so that a computer program can be read from the removable medium 632 and installed in the flash ROM 624 as needed.

The external interface 619 further includes a network interface connected to a predetermined network, such as a LAN or the Internet. The controller 621 may read coded data from the DRAM 618 in accordance with an instruction from the operation unit 622, and supply the coded data via the external interface 619 to another apparatus connected to the network. The controller 621 may also acquire coded data or image data supplied from the other apparatus connected to the network via the external interface 619, and have the acquired data stored in the DRAM 618 or supply the data to the image signal processing unit 614.

The camera 600 uses the image decoding apparatus 151 as the decoder 615. Thus, the decoder 615 can improve the coding efficiency in intra prediction as in the case of the image decoding apparatus 151.

Thus, the camera 600 can generate a predicted image with high accuracy. As a result, the camera 600 can obtain a decoded image of higher resolution from the image data generated in the CCD/CMOS 612, the coded data of video data read from the DRAM 618 or the recording medium 633, or the coded data of video data acquired via the network, and have the decoded image displayed on the LCD 616.

The camera 600 uses the image coding apparatus 51 as the encoder 641. Thus, the encoder 641 can improve the coding efficiency in intra prediction as in the case of the image coding apparatus 51.

Thus, the camera 600 can improve the coding efficiency of coded data recorded in a hard disk, for example. As a result, the camera 600 can utilize the storage area of the DRAM 618 or the recording medium 633 more efficiently.

The decoding method used by the image decoding apparatus 151 may be applied to the decoding process performed by the controller 621. Similarly, the coding method used by the image coding apparatus 51 may be applied to the coding process performed by the controller 621.

The image data acquired by the camera 600 may include a moving image or a still image.

The image coding apparatus 51 and the image decoding apparatus 151 may be applied to apparatuses and systems other than the apparatuses described above.

### REFERENCE SIGNS LIST

51 Image coding apparatus
66 Lossless coding unit
73 Intra prediction unit
74 Line buffer
75 Spline interpolation unit
81 Candidate mode determination unit
82 Predicted image generation unit
83 Cost function calculation unit
84 Mode determination unit
91 Adjacent pixel selection unit
92 Spline parameter generation unit
151 Image decoding apparatus
162 Lossless decoding unit
170 Intra prediction unit
171 Line buffer
172 Spline interpolation unit
181 Prediction mode buffer
182 Predicted image generation unit
191 Adjacent pixel selection unit
192 Spline parameter generation unit

1. An image processing apparatus comprising:
a receiving means for receiving adjacent pixels of a plurality of lines for a current block;
an intra prediction means for generating an intra prediction pixel value for the current block by performing an extrapolation process based on polynomial approximation using the adjacent pixels of the plurality of lines received by the receiving means; and
a coding means for coding an image of the current block on the basis of the generated intra prediction pixel value for the current block.

2. The image processing apparatus according to claim 1, wherein the intra prediction means includes:
a parameter calculation means for calculating an interpolation parameter by polynomial approximation using the adjacent pixels of the plurality of lines;
a predicted image generation means for generating the intra prediction pixel value for the current block by using the interpolation parameter calculated by the parameter calculation means.

3. The image processing apparatus according to claim 2, wherein the intra prediction means performs the extrapolation process by N−1 degree polynomial approximation when using the adjacent pixels of N (N<1) lines received by the receiving means.

4. The image processing apparatus according to claim 3, wherein:
the parameter calculation means calculates N constants of the N−1 degree polynomial by solving N simultaneous equations using the adjacent pixels of the N lines; and
the predicted image generation means generates the intra prediction pixel value for the current block by the N−1 degree polynomial using the N constants calculated by the parameter calculation means.

5. The image processing apparatus according to claim 4, wherein the predicted image generation means clips the generated intra prediction pixel value in a range of values 0 to 2^{N}−1 when an input signal includes an image signal of N bits.

6. The image processing apparatus according to claim 2, wherein the intra prediction means performs the extrapolation process by the polynomial approximation of a degree corresponding to a result of detection of whether an object boundary is included in the adjacent pixels of the N lines received by the receiving means.

7. The image processing apparatus according to claim 6, wherein the intra prediction means makes the determination of the object boundary on the basis of difference information between pixels of the adjacent pixels.

8. The image processing apparatus according to claim 7, wherein the intra prediction means makes the determination of the object boundary on the basis of the difference information between the pixels of the adjacent pixels by using a threshold determined in accordance with a quantization parameter.

9. The image processing apparatus according to claim 8, wherein the threshold is set to be larger for greater quantization parameter.

10. The image processing apparatus according to claim 2, wherein the intra prediction means uses the adjacent pixels of a number of the plurality of lines,
the number of the lines corresponding to the magnitude of a block size of the current block.

11. An image processing method comprising:
a receiving means of an image processing apparatus receiving adjacent pixels of a plurality of lines for a current block;
an intra prediction means of the image processing apparatus generating an intra prediction pixel value for the current block by performing an extrapolation process based on polynomial approximation using the received adjacent pixels of the plurality of lines for the current block; and
a coding means of the image processing apparatus coding an image of the current block on the basis of the generated intra prediction pixel value for the current block.

12. An image processing apparatus comprising:
a decoding means for acquiring an intra prediction mode by decoding coded information coding an image of a current block;
a receiving means for receiving adjacent pixels of a plurality of lines for the current block in accordance with the intra prediction mode; and
an intra prediction means for generating an intra prediction pixel value for the current block by performing an extrapolation process based on polynomial approximation using the adjacent pixels of the plurality of lines received by the receiving means.

13. An image processing method comprising:
a decoding means of an image processing apparatus acquiring an intra prediction mode by decoding coded information coding an image of a current block;
a receiving means of the image processing apparatus receiving adjacent pixels of a plurality of lines for the current block in accordance with the intra prediction mode; and
an intra prediction means of the image processing apparatus generating an intra prediction pixel value for the current block by performing an extrapolation process based on polynomial approximation using the received adjacent pixels of the plurality of lines for the current block.
